(19) United States
(12) Patent Application Publication
(10) Pub. No.: US 2010/0068635 A1
(43) Pub. Date: Mar. 18, 2010

(54) ELECTROPHOTOGRAPHIC PHOTORECEPTOR, AND IMAGE FORMING METHOD, IMAGE FORMING APPARATUS AND PROCESS CARTRIDGE USING THE ELECTROPHOTOGRAPHIC PHOTORECEPTOR

(75) Inventor: Yuuji TANAKA, Numazu-shi (JP)

Correspondence Address: COOPER & DUNHAM, LLP, 30 Rockefeller Plaza, 20th Floor, NEW YORK, NY, 10112, US

(73) Assignee: RICOH COMPANY, LTD., TOKYO (JP)

(21) Appl. No.: 12/556,945

(22) Filed: Sep. 10, 2009

(30) Foreign Application Priority Data
Sep. 16, 2008 (JP) 2008-235992

(51) Int. Cl. G03G 5/04; G03G 15/02; G03G 13/16; G03G 15/00; G03G 21/18

(52) U.S. Cl. 430/58.05; 430/56; 430/125.3; 399/159; 399/111

(57) ABSTRACT

A photoreceptor including a layer including a crosslinked material obtained by polymerizing at least a vinyl group-containing triarylamine compound, a radically polymerizable monomer which has at least three radically polymerizable groups in a molecule and has no charge transport structure, and an optional radically polymerizable polycarbonate. An image forming apparatus including the photoreceptor, a charger configured to charge the photoreceptor, a light irradiating device configured to irradiate the charged photoreceptor to form an electrostatic latent image; a developing device configured to develop the electrostatic latent image with a developer including a toner to form a toner image, and a transferring device configured to transfer the toner image onto a receiving material.

### BACKGROUND OF THE INVENTION

1. Field of the Invention

The present invention relates to an electrophotographic photoreceptor. In addition, the present invention also relates to an image forming method, an image forming apparatus, and a process cartridge using the electrophotographic photoreceptor.

2. Discussion of the Related Art

Organic photoreceptors have various advantages over inorganic photoreceptors because of having good properties. Therefore, organic photoreceptors have been typically used for image forming apparatus such as copiers, facsimiles, laser printers and multifunctional products having copying, facsimileing and printing functions. The advantages thereof are as follows:

(1) Wide optical absorption wavelength range and large light absorption amount (i.e., good optical properties);
(2) High photosensitivity and good charging property (i.e., good electric properties);
(3) Wide flexibility in selecting materials therefor (i.e., various materials can be used therefor);
(4) Good productivity (i.e., they can be easily manufactured);
(5) Low manufacturing costs; and
(6) Good safeness (i.e., they are nontoxic).

Recently, a need exists for a miniaturized image forming apparatus. Therefore, the diameter of the photoreceptors used for image forming apparatus becomes smaller and smaller. In addition, since a need exists for high speed and maintenance-free image forming apparatus, photoreceptors having good durability are greatly desired. Organic photoreceptors do not have good durability. Specifically, organic photoreceptors are generally soft because of typically having a charge transport layer including a low molecular weight charge transport material and an inactive polymer as main components. When such organic photoreceptors are repeatedly used for electrophotographic image forming processes (such as charging, light irradiating, developing, image transferring and cleaning), the surfaces of the photoreceptors are easily abraded particularly in the developing process and cleaning process.

On the other hand, in order to produce high quality images, the particle diameter of toner used as a developer in image forming apparatus becomes smaller and smaller. In order to well remove such small toner from the surface of a photoreceptor using a cleaning blade, the hardness of the blade has to be increased, and in addition the pressure of the blade contacted with the photoreceptor has to be increased, thereby accelerating abrasion of the surface of the photoreceptor. When the surface of a photoreceptor is abraded, the electric properties (such as photosensitivity and charging property) of the photoreceptor deteriorate, resulting in formation of abnormal images (such as low density images and images with background fouling). When a portion of a photoreceptor is mainly abraded, an abnormal streak image is formed.

In attempting to solve the abrasion problem, various proposals have been made. For example, a published unexamined Japanese patent application No (herein after referred to as JP-A) 56-48637 discloses a charge transport layer including a crosslinked binder resin. JP-A 64-1728 (corresponding to U.S. Pat. No. 4,956,440) discloses a charge transport polymer. JP-A 04-281461 discloses a charge transport layer in which an inorganic filler is dispersed. JP-A 08-262779 discloses a photoreceptor in which a crosslinked acrylic resin is included in the outermost layer. JP-As 05-216249 (corresponding to U.S. Pat. Nos. 5,411,827 and 5,496,671) and 05-323630 have disclosed charge transport layers which are prepared by heating or light-irradiating a monomer having a C—C double bond, a charge transport material having a C—C double bond, and a binder resin to react the monomer with the charge transport material. JP-A 2000-66425 (corresponding to U.S. Pat. No. 6,180,303) and 2000-206717 (corresponding to U.S. Pat. No. 6,416,915) have disclosed photosensitive layers including a material obtained by crosslinking a hole transport material having at least two chain-polymerizable functional groups in a molecule.

By using these techniques, the abrasion resistance of organic photoreceptors is improved. However, these photoreceptors tend to cause a new problem. Specifically, when foreign materials are adhered to or a scratch is made on the surfaces of conventional photoreceptors having relatively low abrasion resistance, the foreign materials are easily removed therefrom or the scratch disappears due to refacing of the photoreceptors. Therefore, abnormal images caused by the foreign materials or the scratch are formed only for a short time. In contrast, in the case of the above-mentioned photoreceptors having good abrasion resistance, abnormal images are formed for a relatively long time because the surfaces thereof are hardly refaced and foreign materials are not easily removed therefrom or the scratch hardly disappears.

In particular, recent image forming apparatus are required to produce high quality images while saving energy. Therefore, such image forming apparatus typically use toner having a small particle diameter and a low softening point, and including a particulate inorganic material (such as silica) as an additive (fluidizer). Such image forming apparatus tend to cause a problem in that a particulate inorganic material (silica) sticks into the surface of the photoreceptor thereof in the developing process, and a wax component included in the toner accumulates around the stuck inorganic material, resulting in formation of a white spot in a solid image.

Because of these reasons, a need exists for a photoreceptor which has good abrasion resistance and can produce high quality images over a long period of time without producing defective images such as white spot images.

### SUMMARY OF THE INVENTION

As an aspect of the present invention, a photoreceptor is provided, which includes a layer including a crosslinked material obtained by polymerizing at least a vinyl group-containing triarylamine compound having the below-mentioned formula (1), and a radically polymerizable monomer which has at least three radically polymerizable groups in a molecule and has a non-triarylamine structure (i.e., no charge transport structure):

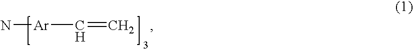

wherein Ar represents an aryl group or a substituted aryl group.

The crosslinked material may be obtained by polymerizing at least a vinyl group-containing triarylamine compound having formula (1), a polycarbonate having a radically polymerizable group, and a radically polymerizable monomer which has at least three radically polymerizable groups in a molecule and has a non-triarylamine structure (i.e., no charge transport structure).

Another aspect of the present invention, an image forming method is provided, which includes:

charging the photoreceptor mentioned above;

irradiating the charged photoreceptor with light to form an electrostatic latent image thereon;

developing the electrostatic latent image with a developer including a toner to form a toner image on the photoreceptor; and

transferring the toner image onto a receiving material.

Yet another aspect of the present invention, an image forming apparatus is provided, which includes:

the photoreceptor mentioned above;

a charger configured to charge the photoreceptor;

a light irradiating device configured to irradiate the charged photoreceptor with imagewise light to form an electrostatic latent image thereon;

a developing device configured to develop the electrostatic latent image with a developer including a toner to form a toner image on the photoreceptor; and

a transferring device configured to transfer the toner image onto a receiving material.

As a further aspect of the present invention, a process cartridge is provided, which includes:

the photoreceptor mentioned above;

at least one of a charger, a light irradiating device, a developing device, a transferring device, a cleaner configured to clean a surface of the photoreceptor, and a discharger configured to reduce charges remaining on the photoreceptor.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

FIG. 1 is a schematic diagram illustrating an example of the image forming apparatus of the present invention and for explaining the image forming method of the present invention;

FIG. 2 is a schematic diagram illustrating another example of the image forming apparatus of the present invention;

FIG. 3 is a schematic diagram illustrating an example of the process cartridge of the present invention; and

FIGS. 4-9 are IR spectra of compounds synthesized in Synthesis Examples 1-6, respectively.

### DESCRIPTION OF THE PREFERRED EMBODIMENTS

At first, the photoreceptor of the present invention will be explained.

The photoreceptor of the present invention has a layer including a crosslinked material obtained by polymerizing at least a vinyl group-containing triarylamine compound having the below-mentioned formula (1), and a radically polymerizable monomer which has at least three radically polymerizable groups in a molecule and has a non-triarylamine structure (hereinafter referred to as no charge transport structure):

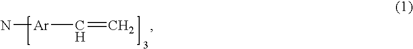

wherein Ar represents an aryl group or a substituted aryl group.

The crosslinked material may be obtained by polymerizing at least a vinyl group-containing triarylamine compound having formula (1), a polycarbonate having a radically polymerizable group, and a radically polymerizable monomer which has at least three radically polymerizable groups in a molecule and has no charge transport structure.

The polymerization reaction can be typically performed by heating the above-mentioned compounds.

It is well known to perform crosslinking polymerization by subjecting a radically polymerizable material to a radiation (such as UV and EB) irradiation treatment or a heat treatment (or without performing such a treatment) in the presence or absence of a polymerization catalyst. In addition, it is well known that such crosslinkable materials cause volume decrease when crosslinked, and particularly UV crosslinkable materials cause serious volume decrease. In this regard, the crosslinked materials are distorted due to internal stress caused by the volume decrease, resulting in deterioration of the mechanical strength of the crosslinked materials.

In the present invention, the radical polymerization reaction is also caused in a drying process in which the coated radical polymerizable compounds are heated to be dried. It is considered that the heat applied to the compounds in the drying process not only proceeds the crosslinking reaction but also relaxes the internal stress, but the detailed crosslinking mechanism is not yet determined. However, the present inventors discover that a crosslinked layer (film) cannot be prepared by radical polymerization if a compound (I) (i.e., a compound having a structure such that a vinyl group is connected with a triphenylamine group via a conjugated bond group) is not used.

The photoreceptor of the present invention has a good combination of abrasion resistance and electric property. In addition, an external additive (such as silica) included in toner used for the developer and having a high hardness hardly sticks into the surface of the photoreceptor, and therefore the above-mentioned white spot problem is hardly caused. The reason therefor is considered as follows.

The outermost layers of conventional photoreceptors are typically constituted of a thermoplastic resin in which a low molecular weight charge transport material is dispersed and which is relatively soft compared to inorganic fillers such as silica included in toner. Therefore, when such conventional photoreceptors are contacted with the toner, the inorganic fillers easily stick into the outermost layers of the photoreceptors. Therefore, it is necessary to enhance the hardness of the outermost layers to prevent occurrence of the problem. The hardness of the outermost layers is hardly enhanced by replacing the low molecular weight with a charge transport polymer, and it is necessary to use a crosslinked resin having a high crosslinking density for the outermost layers. In particular, a crosslinked layer prepared by using a multifunctional monomer is preferably used as an outermost layer.

On the other hand, in order to impart good electric properties to a photoreceptor, a charge transport component is preferably included in the crosslinked outermost layer. In general, components having a triarylamine structure are typically used as charge transport components. Triarylamine has a pyramid-like structure (i.e., a bulky structure) such that three aryl groups are connected with a nitrogen atom, which is present at the peak of the pyramid, wherein the bond angle formed by any two aryl groups is 108°. In addition, monomers having a triarylamine structure have a relatively large molecular weight. Therefore, by using such a triarylamine monomer, the resultant crosslinked layer cannot have a high crosslinking density.

Among various groups having a triarylamine structure, the minimum unit is the triphenylamine group. In the case where a polymerizable group is directly connected with the triphenylamine group, the molecular motion of the crosslinked material is restricted, resulting in deterioration of the charge mobility of the resultant layer. Therefore, the resultant photoreceptor has poor electric properties. Accordingly, it is preferable that the charge transport material has a relatively long conjugated system. However, in this case the crosslinking density decreases. The crosslinking density is an important factor, and by increasing the crosslinking density, the mechanical hardness and electrostatic properties of the resultant layer can be enhanced. However, a layer having as high mechanical hardness as possible is not necessarily preferable as the outermost layer of a photoreceptor, which is repeatedly rubbed by other members (such as developers and cleaning blades), and the layer preferably has toughness as well as hardness. It is considered to be preferable to use a layer having good combination of hardness and toughness as the outermost layer.

When the cross linked material is prepared by polymerizing a monomer having a high polarity (such as acrylic monomers), the resultant crosslinked material has a high specific dielectric constant. In this case, the charge transportability of the layer deteriorates. In contrast, in the present invention, the compound having a charge transportability has a vinyl group, which has low polarity, and therefore the resultant layer has good charge transportability while the layer is well crosslinked by radical polymerization.

Thus, in order to fulfill all of the requirements mentioned above, at least a triarylamine compound having a vinyl group, which serves as a charge transport component, and a radically polymerizable vinyl monomer having no charge transport structure are used for the photoreceptor of the present invention. In addition, a polycarbonate having a radically polymerizable group can be used in combination with a triarylamine compound having a vinyl group, and a radically polymerizable vinyl monomer having no charge transport structure.

Suitable compounds for use as the radically polymerizable monomer having no charge transport structure include radically polymerizable vinyl monomers having a non-pyramid structure.

Specific examples of such radically polymerizable vinyl monomers include (i) comb polymers having at least three vinyl groups in the side chains and/or main chain and having the below-mentioned formula (1); (ii) cyclic monomers having cyclic carbon atoms with which at least three vinyl groups are connected and having the below-mentioned formula (ii); (iii) monomers having a methane-form structure (i.e., monomers having a non-pyramid structure such that a carbon atom is present at the peak of the structure, and four groups extending in the four directions are connected with the center carbon atom (for example, one of the four groups is a hydrogen atom, and the residual three groups are vinyl groups).

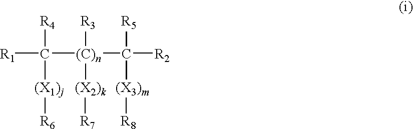

wherein each of R₃ to R₈ represents a hydrogen atom, a substituted or unsubstituted hydrocarbon group, which may be branched, or a hydroxyl group; each of R₁ and R₂ represents a radical polymerizable group; each of X₁ to X₃ represents a divalent organic group; n is a positive integer; and each of j, k and m is 0 or 1

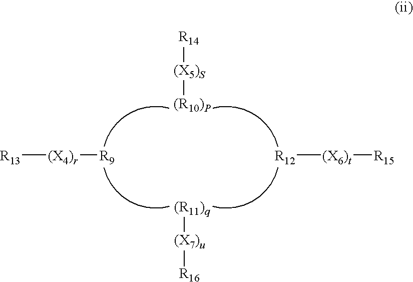

wherein each of R₉ to R₁₂ represents a carbon atom, wherein R₉ to R₁₂ constitute a carbon ring; each of R₁₃ to R₁₆ represents a hydrogen atom, a substituted or unsubstituted hydrocarbon group, which may be branched, a hydroxyl group, or a radically polymerizable group, wherein each of at least three of R₁₃ to R₁₆ is a radically polymerizable group; each of X₄ to X₇ represents a divalent organic group; each of p and q is 0 or a positive integer, wherein p+q≧1; and each of r, s, t and u is 0 or 1.

In this regard, for example, when p is 0, the compound has a three-membered ring without a group including X₅ and R₁₄.

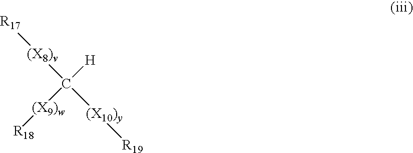

wherein each of R₁₇ to R₁₉ is a radically polymerizable group; each of X₈ to X₁₀ represents a divalent organic group; and each of v, w and y is 0 or 1.

Thus, a layer having good electric properties and an extremely high crosslinking density can be prepared. Therefore, the photoreceptor of the present invention fulfills the photoreceptor requirements mentioned above while hardly causing the sticking problem in that inorganic fillers stick into the surface of the photoreceptor, resulting in prevention of formation of white spot images.

In this regard, the crosslinked material mentioned above preferably has a gel fraction of not less than 95%, and more preferably not less than 97% so that the resultant photoreceptor has excellent abrasion resistance and can produce images with few image defects over a long period of time. In addition, the radically polymerizable monomer having no charge transport structure has at least three radically polymerizable groups in a molecule to impart a good combination of abrasion resistance and scratch resistance to the resultant layer, and it is preferable to use a radically polymerizable monomer having at least five or six radically polymerizable groups in a molecule to enhance the properties.

By using the above-mentioned photoreceptor of the present invention, an image forming method, an image forming apparatus, and a process cartridge, which can produce high quality images over a long period of time, can be provided.

Next, the photoreceptor of the present invention will be explained in detail.

The photoreceptor of the present invention has a layer including a crosslinked material obtained by radically polymerizing at least a vinyl-group containing triarylamine compound serving as a charge transport component and having formula (1), and a radically polymerizable monomer compound having no charge transport structure, for example, without using a polymerization initiator, and optionally has another layer. In this regard, the crosslinked material may be prepared by radically polymerizing at least a vinyl-group containing triarylamine compound serving as a charge transport component and having formula (1), a polycarbonate having a radically polymerizable group, and a radically polymerizable monomer compound having no charge transport structure, for example, without using a polymerization initiator.

Next, the layer including a crosslinked material will be explained in detail.

The layer includes at least a crosslinked material, which is prepared by radically polymerizing at least a vinyl-group containing triarylamine compound serving as a charge transport component and having the below-mentioned formula (1), and a radically polymerizable monomer compound having no charge transport structure.

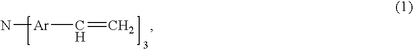

In this regard, the crosslinked material may be prepared by radically polymerizing at least a vinyl-group containing triarylamine compound serving as a charge transport component and having formula (1), a polycarbonate having a radically polymerizable group, and a radically polymerizable monomer compound having no charge transport structure. The layer optionally includes another component, if necessary. wherein Ar represents an aryl group or a substituted aryl group.

Specific examples of such an aryl group include stilbenzyl and biphenyl groups. Stilbenzyl groups are connected with the nitrogen atom and the vinyl group in the cis-form or trans-form. Biphenyl groups are connected with the nitrogen atom at the para-position or meta-position thereof. Vinyl groups are connected with the stilbenzyl group or biphenyl group at the para-position or meta-position thereof.)

It is preferable that in formula (1) all of the three aryl groups Ar are the same as each other. It is also preferable that one of the three aryl groups has a substituent and therefore the compound has an imbalanced structure. Specifically, vinyl group-containing triarylamine compounds having the following formula (3) are preferably used.

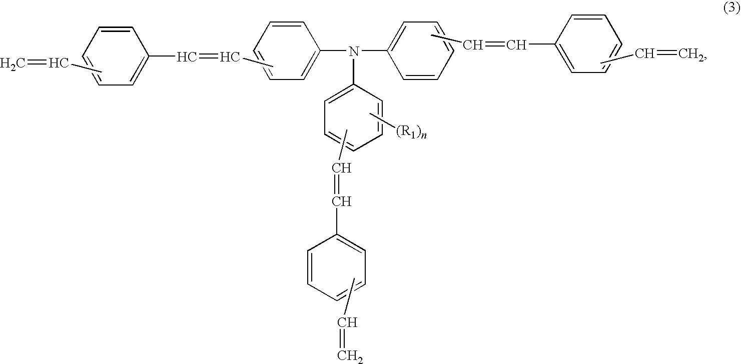

wherein R₁ represents an alkyl group having not greater than 8 carbon atoms, an alkenyl group having not greater than 8 carbon atoms, an alkoxyl group having not greater than 8 carbon atoms, an aryl group having not greater than 8 carbon atoms, or an alaryl group having not greater than 8 carbon atoms; and n is 0, 1, 2 or 3.

In addition, among vinyl group-containing triarylamine compounds having formula (1), tristyrylstyrylamine compounds having the following formula (2) are preferably used.

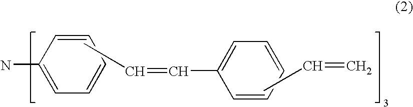

Specific examples of the aryl group Ar of the vinyl group-containing triarylamine compounds having formula (1) are shown in Table 1 below, but are not limited thereto.

TABLE 1

| Compound | |
|---|---|
| No. | Ar |
| 1 | 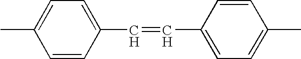 |
| 2 | 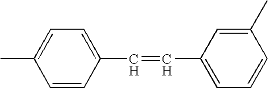 |
| 3 | 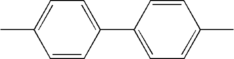 |
| 4 | 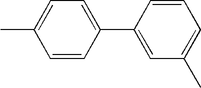 |
| 5 | 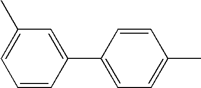 |
| 6 | 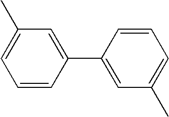 |

Next, the method for preparing vinyl group-containing triarylamine compounds having formula (1) will be explained.

For example, an aldehyde compound is synthesized, and then the aldehyde compound is reacted with a phosphonium salt compound to prepare a vinyl group-containing triarylamine compound. Alternatively, a bromo compound is reacted with a boronic acid compound to prepare a vinyl group-containing triarylamine compound.

The method will be explained in detail.

### <Example 1 of Synthesis of Aldehyde Compound>

As illustrated in the below-mentioned reaction formula, a tribromotriphenylamine compound is formylated using a conventional method to prepare an aldehyde compound.

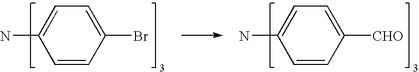

Suitable methods for preparing the intermediate compounds (i.e., aldehyde compounds) using the above-mentioned reaction include methods using lithium/dimethylformamide, but are not limited thereto. Specific examples of the methods are explained in Examples below.

<Example 2 of synthesis of aldehyde compound>

As illustrated in the below-mentioned reaction formula, a triphenylamine compound is formylated using a conventional method to prepare an aldehyde compound.

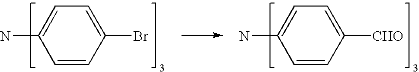

Suitable methods for preparing the intermediate compounds (i.e., aldehyde compounds) using the above-mentioned reaction include methods using zinc chloride/phosphorous oxychloride/dimethylformamide, but are not limited thereto. Specific examples of the methods are explained in Examples below.

<Example 1 of synthesis of vinyl group-containing triarylamine compound>

As illustrated in the below-mentioned reaction formula, an aldehyde compound is reacted with a phosphonium salt compound using a conventional synthesis method to prepare a vinyl group-containing triarylamine compound.

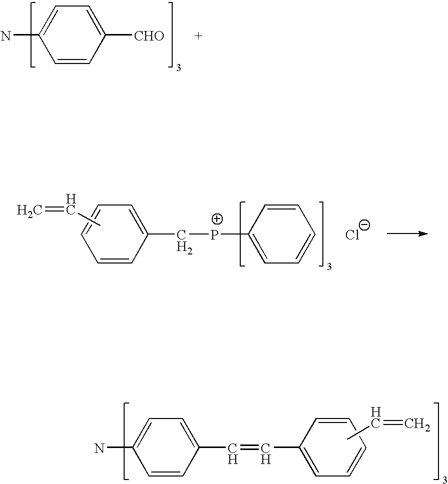

Suitable methods for preparing the vinyl group-containing triarylamine compounds using the above-mentioned reaction include the Wittig method using potassium t-butoxide/dimethylfromamide, but are not limited thereto. Specific examples of the methods are explained in Examples below.

<Example 2 of synthesis of vinyl group-containing triarylamine compound>

As illustrated in the below-mentioned reaction formula, a bromo compound is reacted with a boronic acid compound using a conventional synthesis method to prepare a vinyl group-containing triarylamine compound.

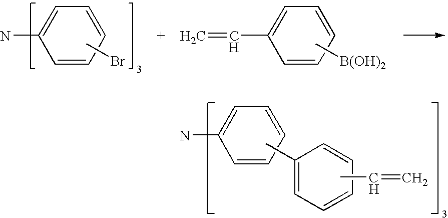

Suitable methods for preparing the vinyl group-containing triarylamine compounds using the above-mentioned reaction include the Suzuki Coupling Reaction method using potassium carbonate/triphenyl phosphine palladium catalyst, but are not limited thereto. Specific examples of the methods are explained in Examples below.

As mentioned above, the vinyl group-containing triarylamine compounds for use in preparing the photoreceptor of the present invention have a triarylamine structure such that a stilbenzyl group or a biphenyl group is included in the structure, i.e., an extended conjugated system is included therein. Therefore, the vinyl group-containing triarylamine compounds have high hole mobility (i.e., good charge transportability). In addition, since a vinyl group is incorporated in the triarylamine compounds, the compounds have good chain polymerizability (for example, good radical polymerizability)

Therefore, even when a polymerization initiator is not used, a crosslinked layer having a high crosslinking density can be prepared by radically polymerizing the compounds. Alternatively, a crosslinked layer having a high crosslinking density can be prepared by irradiating the compounds with ultraviolet rays (UV), electron beams (ER), and radiation ray or by using a radical polymerization initiator. The resultant crosslinked layer has a good combination of film forming property, mechanical resistance (e.g., abrasion resistance), heat resistance, and charge transportability. Therefore, the layer (film) can be preferably used as an organic functional material for use in organic photoreceptors, organic electroluminescence devices (EL), organic thin film transistors (TFT), and organic semiconductors such as solar batteries.

The vinyl group-containing triarylamine compounds mentioned above can be well mixed with other radically polymerizable monomers. Specific examples of such radically polymerizable monomers include trivinyl cyclohexane (TVC), trimethylolpropane triacrylate (TMPTA), trimethylolpropane alkylene-modified triacrylate, trimethylolpropane ethyleneoxy-modified triacrylate, trimethylolpropane propyleneoxy-modified triacrylate, trimethylolpropane caprolactone-modified triacrylate, trimethylolpropane alkylene-modified trimethacrylate, pentaerythritol triacrylate, pentaerythritol tetraacrylate (PETTA), glycerol triacrylate, glycerol epichlorohydrin-modified triacrylate, glycerol ethyleneoxy-modified triacrylate, glycerol propyleneoxy-modified triacrylate, tris(acryloxyethyl)isocyanurate, dipentaerythritol hexaacrylate (DPHA), dipentaerythritol caprolactone-modified hexaacrylate, dipentaerythritol hydroxypentaacrylate, alkylated dipentaerythritol pentaacrylate, alkylated dipentaerythritol tetraacrylate, alkylated dipentaerythritol triacrylate, dimethylolpropane tetraacrylate (DTMPTA), pentaerhythritol ethoxytetraacrylate, ethyleneoxy-modified triacryl phosphate, 2,2,5,5-tetrahydroxymethyl cyclopentanone tetraacrylate, etc.

One or more of these monomers can be used in combination with the vinyl group-containing trimethylamine compounds so that the resultant layer has the desired properties. The added amount of these monomers is 0.01 to 1,500 parts by weight, and preferably from 1 to 500 parts by weight, based on 100 parts by weight of the vinyl group-containing trimethylamine compounds used.

As mentioned above, when preparing the crosslinked material, a radically polymerizable monomer having at least three radically polymerizable groups and having no charge transport structure is used in combination with a vinyl group-containing triarylamine compound. Specifically, the monomers have at least three radically polymerizable groups and do not include hole transport structures such as triarylamine structure, hydrazone structure, pyrazoline structure, and carbazole structure; and electron transport structures (or electron transport groups) such as condensed polycyclic quinone structure, diphenoquinone structure, and electron accepting aromatic groups including a cyano or nitro group.

Suitable radically polymerizable functional groups included in the monomers include groups, which have a C—C double bond and are radically polymerizable. Specific examples of the radically polymerizable functional groups include 1-substituted ethylene groups and 1,1-substituted ethylene groups, which are explained below.

### (1-Substituted Ethylene Groups)

Specific examples of the 1-substituted ethylene groups include the following group (6):

CH₂═CH—X₁— (6)

wherein X₁ represents a substituted or unsubstituted arylene group (such as phenylene and naphthylene groups), a substituted or unsubstituted alkenylene group, a —CO— group, a —COO— group, a —CON(R₁) group (R₁ represents a hydrogen atom, an alkyl group (e.g., methyl and ethyl groups), an aralkyl group (e.g., benzyl, naphthylmethyl and phenetyl groups), or an aryl group (e.g., phenyl and naphthyl groups)) or a —S— group.

Specific examples of the groups having formula (6) include a vinyl group, a styryl group, 2-methyl-1,3-butadienyl group, a vinylcarbonyl group, an acryloyloxy group, an acryloylamide group, a vinylthioether group, etc.

### (1,1-Substituted Ethylene Groups)

Specific examples of the 1,1-substituted ethylene groups include the following group (7):

CH₂═C(Y)—(X₂)ₙ— (7)

wherein Y represents a substituted or unsubstituted alkyl group, a substituted or unsubstituted aralkyl group, a substituted or unsubstituted aryl group (such as phenyl and naphthyl groups), a halogen atom, a cyano group, a nitro group, an alkoxyl group (such as methoxy and ethoxy groups), or a —COOR₂ group (wherein R₂ represents a hydrogen atom, a substituted or unsubstituted alkyl group (such as methyl and ethyl groups), a substituted or unsubstituted aralkyl group (such as benzyl and phenethyl groups), a substituted or unsubstituted aryl group (such as phenyl and naphthyl groups) or a —CONR₃R₄ group (wherein each of R₃ and R₄ represents a hydrogen atom, a substituted or unsubstituted alkyl group (such as methyl and ethyl groups), a substituted or unsubstituted aralkyl group (such as benzyl, naphthylmethyl and phenethyl groups), a substituted or unsubstituted aryl group (such as phenyl and naphthyl groups)); X₂ represents a group selected from the groups mentioned above for use in X₁ and an alkylene group, wherein at least one of Y and X₂ is an oxycarbonyl group, a cyano group, an alkenylene group or an aromatic ring group; and n is 0 or 1.

Specific examples of the groups having formula (7) include an α-chloroacryloyloxy group, a methacryloyloxy group, an α-cyanoethylene group, an α-cyanoacryloyloxy group, an α-cyanophenylene group, a methacryloylamino group, etc.

Specific examples of the substituents of the groups X₁, X₂ and Y include halogen atoms, nitro groups, cyano groups, alkyl groups (such as methyl and ethyl groups), alkoxyl groups (such as methoxy and ethoxy groups), aryloxy groups (such as a phenoxy group), aryl groups (such as phenyl and naphthyl groups), aralkyl groups (such as benzyl and phenethyl groups), etc.

Among these functional groups, acryloyloxy and methacryloyloxy groups are preferable. Compounds having three or more (meth) acryloyloxy groups can be prepared by subjecting (meth)acrylic acid (salts), (meth)acrylhalides and (meth)acrylates, which have three or more hydroxyl groups, to an esterification reaction or an ester exchange reaction. The radically polymerizable functional groups included in a radically polymerizable monomer may be the same as or different from the others therein.

Specific examples of the radically polymerizable monomers having at least three functional groups and having no charge transport structure include 1,2,4-trivinyl cyclohexane (TVC), trimethylolpropane triacrylate (TMPTA), trimethylolpropane trimethacrylate, trimethylolpropane alkylene-modified triacrylate, trimethylolpropane ethyleneoxy-modified triacrylate, trimethylolpropane propyleneoxy-modified triacrylate, trimethylolpropane caprolactone-modified triacrylate, trimethylolpropane alkylene-modified trimethacrylate, pentaerythritol triacrylate, pentaerythritol tetraacrylate (PETTA), glycerol triacrylate, glycerol epichlorohydrin-modified triacrylate, glycerol ethyleneoxy-modified triacrylate, glycerol propyleneoxy-modified triacrylate, tris(acryloxyethyl)isocyanurate, dipentaerythritol hexaacrylate (DPHA), dipentaerythritol caprolactone-modified hexaacrylate, dipentaerythritol hydroxypentaacrylate, alkylated dipentaerythritol pentaacrylate, alkylated dipentaerythritol tetraacrylate, alkylated dipentaerythritol triacrylate, dimethylolpropane tetraacrylate (DTMPTA), pentaerhythritol ethoxytetraacrylate, ethyleneoxy-modified triacryl phosphate, 2,2,5,5-tetrahydroxymethylcyclopentanone tetraacrylate, etc. These compounds can be used alone or in combination.

Among radically polymerizable tri- or more-functional monomers having no charge transport structure, 1,2,4-trivinylcyclohexane having the following formula (4) is preferably used.

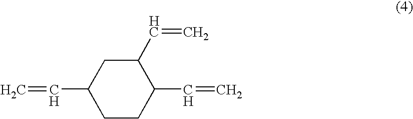

When 1,2,4-trivinylcyclohexane is reacted with a vinyl group-containing triarylamine compound (optionally together with a radically polymerizable polycarbonate), it is possible to use no polymerization initiator.

In order to form a dense crosslinked network in the crosslinked layer, the ratio (Mw/F) of the weight average molecular weight (Mw) of a radically polymerizable monomer having at least three functional groups and no charge transport structure to the number of functional groups (F) included in a molecule of the compound is preferably not greater than 250. When the number is too large, the resultant layer becomes soft and thereby the abrasion resistance of the layer is slightly deteriorated. In this case, it is not preferable to use only one monomer including a functional group having an extremely long chain group when the monomer is modified with a group such as ethylene oxide, propylene oxide and caprolactone.

The content of the unit obtained from a radically polymerizable monomer having at least three functional groups and no charge transport structure in the crosslinked layer is preferably from 20 to 80% by weight, and more preferably from 30 to 70% by weight, based on the total weight of the crosslinked layer. The content of the unit substantially depends on the ratio of the radically polymerizable monomer to the total of the solid components included in the coating liquid. When the content is too low, the three dimensional crosslinking density is low, and thereby abrasion resistance much better than those of conventional protective layers prepared by using a thermoplastic binder resin cannot be imparted to the resultant layer. In contrast, when the content of the unit is too high, the content of the charge transport compound decreases, thereby deteriorating the electric properties of the layer. Therefore, it is preferable that the content of the unit falls in the above-mentioned range.

When the content of the unit in the crosslinked layer is too high, the charge transportability of the resultant layer deteriorates, resulting in deterioration of the photosensitivity of the photoreceptor (i.e., increase of irradiated portions of the photoreceptor). Particularly, when the layer including the crosslinked material has a thickness of not less than 3 μm, there is a case where the photoreceptor cannot function as a photoreceptor. In contrast, when the content is too low, the crosslinking density of the resultant layer decreases, and thereby excellent abrasion resistance cannot be acquired.

As mentioned above, a radically polymerizable polycarbonate is optionally used in combination with a vinyl group-containing triarylamine compound and a radically polymerizable tri- or more-functional monomer having no charge transport structure. Among various radically polymerizable polycarbonates, polycarbonates having the following formula (5) are preferably used.

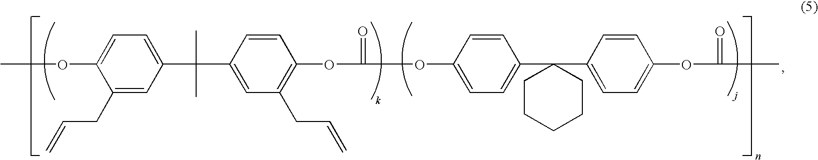

wherein k and j represent the molar ratio of the units and each of k and j is a positive integer; and n is the repeat number of the combined unit, and is a positive integer.

As mentioned above, the crosslinked layer is preferably prepared by reacting (crosslinking) at least a radically polymerizable tri- or more-functional monomer having no charge transport structure, and a vinyl group-containing triarylamine compound having formula (1) optionally together with a polycarbonate having a radically polymerizable group and a polymerization initiator. However, in order to reduce the viscosity of the coating liquid, to relax the stress of the crosslinked layer, and to reduce the surface energy and friction coefficient of the resultant layer, known radically polymerizable mono- or di-functional monomers, functional monomers and radically polymerizable oligomers can be used in combination therewith.

Specific examples of the radically polymerizable monofunctional monomers include 2-ethylhexyl acrylate, 2-hydroxyethyl acrylate, 2-hydroxypropyl acrylate, tetrahydrofurfuryl acrylate, 2-ethylhexylcarbitol acrylate, 3-methoxybutyl acrylate, benzyl acrylate, cyclohexyl acrylate, isoamyl acrylate, isobutyl acrylate, methoxytriethyleneglycol acrylate, phenoxytetraethyleneglycol acrylate, cetyl acrylate, isostearyl acrylate, stearyl acrylate, styrene, etc.

Specific examples of the radically polymerizable di-functional monomers include 1,3-butanediol diacrylate, 1,4-butanediol diacrylate, 1,4-butanediol dimethacrylate, 1,6-hexanediol diacrylate, 1,6-hexanediol dimethacrylate, diethylene glycol diacryalte, neopentylglycol diacrylate, binsphenol A-ethyleneoxy-modified diacrylate, bisphenol F-ethyleneoxy-modified diacrylate, neopentylglycol diacryalte, etc.

Specific examples of the functional monomers include fluorine-containing monomers such as octafluoropentyl acrylate, 2-perfluorooctylethyl acrylate, 2-perfluorooctylethyl methacrylate, and 2-perfluoroisononylethyl acrylate; vinyl monomers having apolysiloxane group such as siloxane units having a repeat number of from 20 to 70, which are described in JP-Ss 05-60503 and 06-45770 (e.g., acryloylpolydimethylsiloxaneethyl, methacryloylpolydimethylsiloxaneethyl, acryloylpolydimethylsiloxanepropyl, acryloylpolydimethylsiloxanebutyl, and diacryloylpolydimethylsiloxanediethyl); acrylates; and methacrylates.

Specific examples of the radically polymerizable oligomers include epoxyacryalte oligomers, urethane acrylate oligomers, polyester acrylate oligomers, etc.

When a large amount of the radically polymerizable mono- or di-functional monomers or radically polymerizable oligomers are used, the three dimensional crosslinking density of the crosslinked layer decreases, thereby deteriorating the properties (such as abrasion resistance) of the layer. Therefore, the added amount of a radically polymerizable mono- or di-functional monomer or a radically polymerizable oligomer is preferably not greater than 50 parts by weight, and more preferably not greater than 30 parts by weight, per 100 parts by weight of the radically polymerizable tri- or more-functional monomer having no charge transport structure used.

Next, the method for synthesizing radically polymerizable tri- or more-functional monomers having no charge transport structure will be explained.

### <Synthesis of Phosphonium Compound>

As illustrated in the below-mentioned reaction formula, a phosphonium salt compound is synthesized from a halogenated compound using a conventional synthesis method.

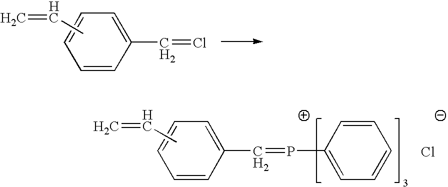

Thus, the synthesis method using triphenyl phosphine is typically used. However, the method of preparing a phosphonium salt compound (serving as an intermediate of a radically polymerizable tri- or more-functional monomer) is not limited thereto.

Next, the detailed synthesis method will be explained.

### Synthesis Examples

### Synthesis Example 1

### Preparation of 4,4′,4″-triformyltriphenylamine

The following components were fed into a reaction vessel equipped with an agitator, a thermometer, and a dropping funnel.

| | | |
|---|---|---|
| Tris(4-bromophenyl)amine | 24.1 | g |
| (from Tokyo Kasei Kogyo Co., Ltd.) | | |
| Dehydrated tetrahydrofuran | 200 | ml |

The components were agitated at −72° C. in an argon atmosphere.

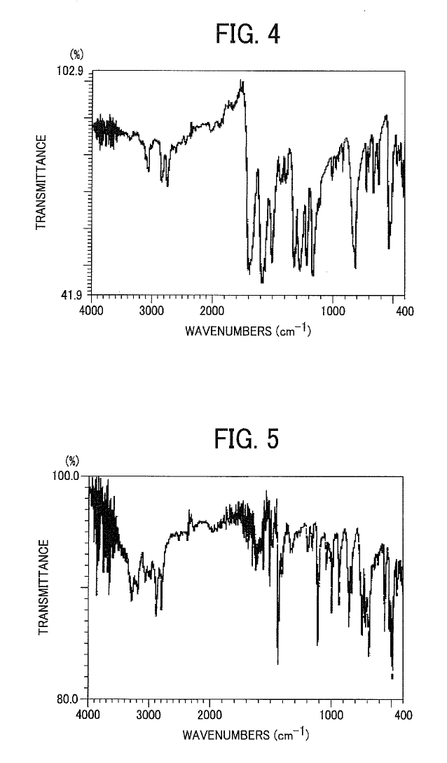

After 65 ml of a 2.77M hexane solution of n-butyl lithium was dropped therein, the mixture was reacted for 1 hour. In addition, after 16.45 g of dehydrated dimethylformamide was dropped therein, the mixture was further reacted for 2 hour. The reaction product was fed into ice water, followed by an extraction treatment using methylene chloride. After the extracted organic phase was washed with water, the organic phase was obtained by separation. After the organic phase was dried using magnesium sulfate, the organic phase was condensed at a reduced pressure. The residual material was refined using a silica gel chromatography (solvent: toluene/ethyl acetate=9/1). Thus, 17.17 g of a yellow powder (i.e., the target compound) was obtained. The IR spectrum of the compound is illustrated in FIG. 4.

### Synthesis Example 2

### Preparation of Phosphonium Salt Compound

The following components were fed into a reaction vessel equipped with an agitator, and a thermometer.

| | | |
|---|---|---|
| 4-Chloromethylstyrene | 152.62 | g |
| (from Tokyo Kasei Kogyo Co., Ltd.) | | |
| Triphenylphosphine | 262.29 | g |
| (from Tokyo Kasei Kogyo Co., Ltd.) | | |
| Toluene | 200 | ml |

The components were reacted at 80° C. for 3 hours. After the reaction, the reaction product was filtered, followed by washing using toluene, and drying at a reduced pressure. Thus, 376 g of a white powder (a phosphonium salt compound) was prepared. The IR spectrum of the phosphonium salt compound is illustrated in FIG. 5.

### Synthesis Example 3

### Preparation of compound No. 1 listed in Table 1

The following components were fed into a reaction vessel equipped with an agitator, and a thermometer.

| | | |
|---|---|---|
| 4,4′,4″-triformyltriphenylamine | 6.58 | g |
| The phosphonium salt compound prepared above | 127.38 | g |
| Dehydrated dimethylformamide | 100 | ml |

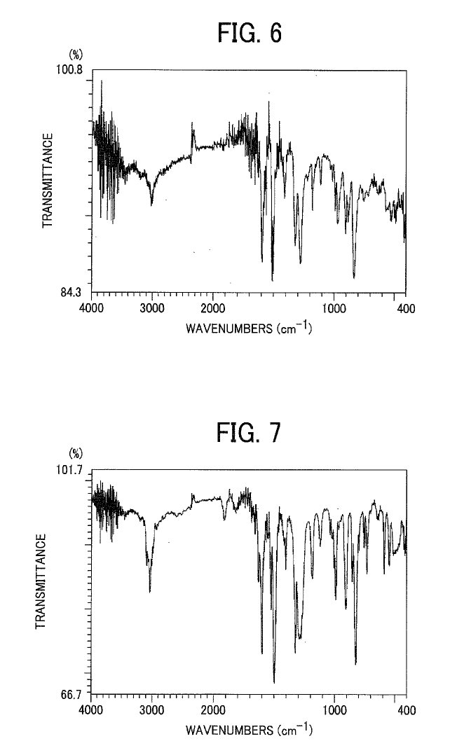

The mixture was agitated while cooled by an ice bath. After 8.08 g of potassium t-butoxide was added thereto, the mixture was reacted for 3 hours at room temperature. After the reaction, the reaction product was fed into ice water, followed by an extraction treatment using methylene chloride. After the extracted organic phase was washed with water, the organic phase was obtained by separation. After the organic phase was dried using magnesium sulfate, the organic phase was condensed at a reduced pressure. The residual material was refined using a silica gel chromatography (solvent: dichloromethane/cyclohexane=3/7). Thus, 9.88 g of a yellow amorphous material (i.e., the target compound) was obtained. The IR spectrum of the compound is illustrated in FIG. 6.

### Synthesis Example 4

### Preparation of compound No. 3 listed in Table 1

The following components were fed into a reaction vessel equipped with an agitator, a thermometer, and a condenser.

| | | |
|---|---|---|
| Tris(4-bromophenyl)amine | 2.09 | g |
| (from Tokyo Kasei Kogyo Co., Ltd.) | | |
| 4-Vinylphenylboronic acid | 2.31 | g |
| (from Sigma-Aldrich Co.) | | |
| Potassium carbonate | 2.157 | g |
| Ethanol | 5 | ml |
| Toluene | 10 | ml |
| Ion-exchange water | 10 | ml |

The components were agitated at room temperature in an argon atmosphere. Next, 0.3 g of tetrakistriphenylphosphine palladium (from Tokyo Kasei Kogyo Co., Ltd.) was added to the mixture, and the mixture was reacted for 5 hours at 70° C. After the reaction, the reaction product was fed into ice water, followed by an extraction treatment using methylene chloride. After the extracted organic phase was washed with water, the organic phase was obtained by separation. After the organic phase was dried using magnesium sulfate, the organic phase was condensed at a reduced pressure. The residual material was refined using a silica gel chromatography (solvent: dichloromethane/cyclohexane=1/1). Thus, 2.15 g of a pale-yellowish white powder (i.e., the target compound) was obtained. The IR spectrum of the compound is illustrated in FIG. 7.

### Synthesis Example 5

### Synthesis of Tris(3-Bromophenyl)Amine (Serving as Intermediate)

The following components were fed into a reaction vessel equipped with an agitator, a thermometer, and a condenser.

| | | |
|---|---|---|
| 3-Bromoaniline | 6.88 | g |
| (from Tokyo Kasei Kogyo Co., Ltd.) | | |
| 3-Bromoiodobenzene | 33.95 | g |
| (from Tokyo Kasei Kogyo Co., Ltd.) | | |
| Potassium carbonate | 22.11 | g |
| o-Dichlorobenzene | 40 | ml |

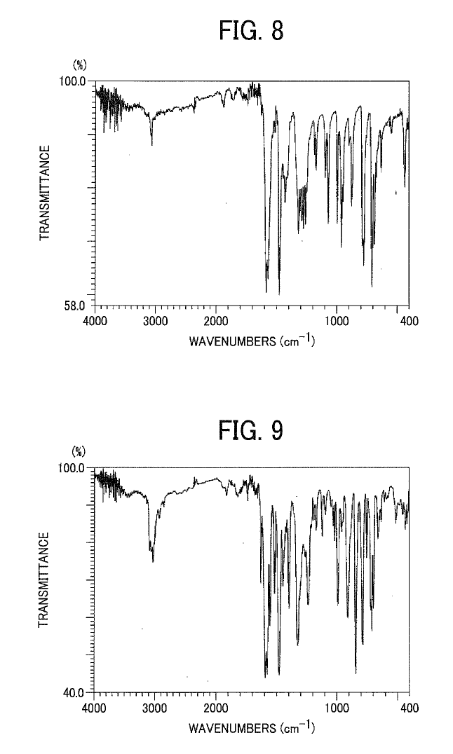

The mixture was agitated for 24 hours while refluxed in an argon atmosphere to be reacted. After the reaction, the reaction product was fed into ice water, followed by an extraction treatment using methylene chloride. After the extracted organic phase was washed with water, the organic phase was obtained by separation. After the organic phase was dried using magnesium sulfate, the organic phase was condensed at a reduced pressure. The residual material was refined using a silica gel chromatography (solvent: dichloromethane/cyclohexane=1/5), followed by a recrystallization refinement treatment using ethanol. Thus, 7.02 g of a white powder (i.e., the target compound) was obtained. The IR spectrum of the compound is illustrated in FIG. 8.

### Synthesis Example 6

### Synthesis of compound No. 5 listed in Table 1

| | | |
|---|---|---|
| Tris(3-bromophenyl)amine | 2.41 | g |
| (prepared in Synthesis Example 5) | | |
| 4-Vinylphenylboronic acid | 2.66 | g |
| (from Sigma-Aldrich Co.) | | |
| Potassium carbonate | 2.48 | g |
| Ethanol | 5 | ml |
| Toluene | 10 | ml |
| Ion-exchange water | 10 | ml |

The components were agitated at room temperature in an argon atmosphere. Next, 0.35 g of tetrakistriphenylphosphine palladium (from Tokyo Kasei Kogyo Co., Ltd.) was added to the mixture, and the mixture was reacted for 5 hours at 70° C. After the reaction, the reaction product was fed into ice water, followed by an extraction treatment using methylene chloride. After the extracted organic phase was washed with water, the organic phase was obtained by separation. After the organic phase was dried using magnesium sulfate, the organic phase was condensed at a reduced pressure. The residual material was refined using a silica gel chromatography (solvent: dichloromethane/cyclohexane=1/1). Thus, 2.15 g of a white amorphous material (i.e., the target compound) was obtained. The IR spectrum of the compound is illustrated in FIG. 9.

As mentioned above, the vinyl compounds having formula (1) for use in the photoreceptor of the present invention can be easily prepared by using a combination of an aldehyde compound and a phosphonium salt compound or a combination of a bromo compound and a boronic acid compound as intermediates. The other compounds listed in Table 1 can also be prepared by a similar method.

Vinyl group-containing triarylamine compounds having formula (1) are used for imparting good charge transportability to the resultant crosslinked material (layer). The content of the unit obtained from a vinyl group-containing triarylamine compound in the crosslinking layer is preferably from 20 to 80% by weight, and more preferably from 30 to 70% by weight. When the content of the unit in the crosslinked layer is too low, the charge transportability of the resultant layer deteriorates, resulting in deterioration of the electric properties of the photoreceptor (such as deterioration photosensitivity of the photoreceptor and increase of potential of irradiated portions (i.e., residual potential) of the photoreceptor) after repeated use. In contrast, when the content is too high, the crosslinking density of the resultant layer decreases because the content of the unit obtained from a radically polymerizable monomer decreases, and thereby the desired property (excellent abrasion resistance) cannot be acquired.

Next, the method for forming a layer including the above-mentioned crosslinked material will be explained.

The layer can be typically prepared by coating a coating liquid including a radically polymerizable tri- or more-functional monomer and a vinyl group-containing triarylamine compound having formula (1), and optionally including a radically polymerizable polycarbonate, and then drying the coated liquid to polymerize the compounds.

When the polymerizable monomer used is liquid, other components to be included in the coating liquid may be dissolved therein. In this case, the coating liquid can be prepared without using a solvent. However, if necessary, solvents can be used for preparing the coating liquid.

Specific examples of the solvents include alcohols such as methanol, ethanol, propanol, and butanol; ketones such as acetone, methyl ethyl ketone, methyl isobutyl ketone, and cyclohexanone; esters such as ethyl acetate, and butyl acetate; ethers such as tetrahydrofuran, dioxane, and propyl ether; halogenated solvents such as dichloromethane, dichloroethane, trichloroethane, and chlorobenzene; aromatic solvents such as benzene, toluene, and xylene; cellosolves such as methyl cellosolve, ethyl cellosolve and cellosolve acetate; etc. These solvents can be used alone or in combination. The added amount of a solvent is not particularly limited, and is determined depending on the solubility of the components, coating methods, and the target thickness of the protective layer. Suitable coating methods for use in coating the coating liquid include dip coating, spray coating, bead coating, and ring coating.

In order to relax the stress of the crosslinked layer and to improve the adhesion of the layer to the adjacent layer, the coating liquid can include additives such as plasticizers, leveling agent, and low molecular weight charge transport materials having no radical polymerizability.

Specific examples of the plasticizers include known plasticizers for use in general resins, such as dibutyl phthalate, and dioctyl phthalate. The added amount of the plasticizers in the coating liquid is preferably not greater than 20% by weight, and more preferably not greater than 10% by weight, based on the total of solid components included in the coating liquid.

Specific examples of the leveling agents include silicone oils (such as dimethylsilicone oils, and methylphenylsilicone oils), and polymers and oligomers having a perfluoroalkyl group in their side chains. The added amount of the leveling agents is preferably not greater than 3% by weight based on the total of solid components included in the coating liquid.

After the coating liquid is coated, the coated liquid is subjected to a heat drying treatment. In this heat drying treatment, the layer is crosslinked. In order to attain the object of the present invention, the crosslinked material preferably has a gel fraction of not less than 95%, and more preferably not less than 97%. In this regard, the gel fraction of a crosslinked material is determined by the following method. (1) At first, a crosslinked material, which has been weighed (the weight is W1), is dipped in an organic solvent having high dissolving power (such as tetrahydrofuran) for 5 days; and (2) after drying the solvent, the crosslinked material is weighed (the weight is W2) again to determine the weight loss. The gel fraction can be determined by the following equation.

GF (%)=100×(W2/W1),

wherein GF represents the gel fraction of the crosslinked material; W1 represents the weight of the crosslinked material before the dipping treatment; and W2 represents the weight of the crosslinked material after the dipping treatment.

In order to prepare a crosslinked layer having a gel fraction of not less than 95% (and preferably not less than 97%), the coated layer is preferably dried at a temperature not lower than 130° C. and more preferably not lower than 150° C. When the crosslinked layer has such a high gel fraction, occurrence of the sticking problem in that inorganic fillers such as silica stick into the layer can be prevented.

The layer structure of the photoreceptor of the present invention is not particularly limited, but the crosslinked layer is preferably the outermost layer of the photoreceptor. Since the compound having formula (1) has good hole transportability, the crosslinked layer is preferably formed as the outermost layer of photoreceptors used for negative charging methods.

The photoreceptor of the present invention specifically includes a substrate, an undercoat layer located on the substrate, a charge generation layer located on the undercoat layer, a charge transport layer located on the charge generation layer and including the crosslinked material. In this case, the charge transport layer cannot be well crosslinked depending on the crosslinking conditions when the charge transport layer is relatively thick. Therefore, it is preferable to form a crosslinked second charge transport layer, which includes the crosslinked material, on the (first) charge transport layer.

The crosslinked second charge transport layer preferably has a thickness of not less than 3 μm. When the thickness is less than 3 μm, the charge transport components included in the first charge transport layer migrate into the second charge transport layer in the second charge transport layer coating process, thereby affecting the crosslinking reaction, resulting in decrease of the crosslinking density of the second charge transport layer. Thus, by forming a crosslinked second charge transport layer having a thickness of not less than 3 μm, the resultant layer has a high crosslinking density, and thereby occurrence of the sticking problem can be prevented. In addition, when the outermost layer is abraded after long repeated use in such a manner that the ratio of the thickness of the abraded portion of the layer to the original thickness of the layer is relatively large, the charging properties and photosensitivity of the photoreceptor seriously change. From this point of view, the crosslinked second charge transport layer preferably has a thickness of not less than 3 μm.

Thus, the photoreceptor of the present invention preferably includes a substrate, and a charge generation layer, a (first) charge transport layer, and a crosslinked (second) charge transport layer including the crosslinked material, which layers are overlaid on the substrate in this order. The photoreceptor optionally includes other layers such as an undercoat layer located between the substrate and the charge generation layer.

Next, the layers will be explained in detail.

### (Charge Generation Layer)

The charge generation layer includes a charge generation material having a charge generation function as a main component, and optionally includes a binder resin and other components.

Known charge generation materials such as inorganic charge generation materials and organic charge generation materials can be used as the charge generation material. Specific examples of the inorganic charge generation materials include crystalline selenium, amorphous selenium, selenium-tellurium compounds, selenium-tellurium-halogen compounds, selenium-arsenic compound, amorphous silicon, etc. In addition, amorphous silicon in which a dangling bond is terminated with a hydrogen atom or a halogen atom or in which a boron atom, a phosphorous, atom is doped can be preferably used.

Known organic charge generation materials can be used. Specific examples thereof include phthalocyanine pigments such as metal phthalocyanine and metal-free phthalocyanine; azulenium salt type pigments; squaric acid methyne pigments; azo pigments having a carbazole skeleton; azo pigments having a triphenyl amine skeleton; azo pigments having a diphenyl amine skeleton; azo pigments having a dibenzothiophene skeleton; azo pigments having a fluorenone skeleton; azo pigments having an oxadiazole skeleton; azo pigments having a bisstilbene skeleton; azo pigments having a distyryloxadiazole skeleton; azo pigments having a distyrylcarbazole skeleton; perylene pigments; anthraquinone pigments, polycyclic quinone pigments, quinone imine pigments, diphenylmethane pigments, triphenylmethane pigments, benzoquinone pigments, naphthoquinone pigments, cyanine pigments, azomethine pigments, indigoide pigments, benzimidazole pigments, etc. These are used alone or in combination.

Specific examples of the binder resins, which are optionally included in the charge generation layer, include polyamide, polyurethane, epoxy resins, polyketone, polycarbonate, silicone resins, acrylic resins, polyvinyl butyral, polyvinyl formal, polyvinyl ketone, polystyrene, poly-N-vinylcarbazole, polyacrylamide, etc. These resins can be used alone or in combination.

In addition, charge transport polymers having a charge transport function such as (1) polymers (e.g., polycarbonates, polyesters, polyurethanes, polyethers, polysiloxanes, and acrylic resins), which have an arylamine skeleton, a benzidine skeleton, a hydrazone skeleton, a carbazole skeleton, a stilbene skeleton, and/or a pyrazoline skeleton, and (2) polymers having a polysilane skeleton can also be used alone or in combination as the binder resin.

Specific examples of the charge transport polymers (1) include charge transport polymers disclosed in JP-As 01-001728, 01-009964, 01-013061, 01-019049, 01-241559, 04-011627, 04-175337, 04-183719, 04-225014, 04-230767, 04-320420, 05-232727, 05-310904, 06-234836, 06-234837, 06-234838, 06-234839, 06-234840, 06-234841, 06-236049, 06-236050, 06-236051, 06-295077, 07-056374, 08-176293, 08-208820, 08-211640, 08-253568, 08-269183, 09-062019, 09-043883, 09-71642, 09-87376, 09-104746, 09-110974, 09-110976, 09-157378, 09-221544, 09-227669, 09-235367, 09-241369, 09-268226, 09-272735, 09-302084, 09-302085, and 09-328539.

Specific examples of the polysilylene polymers (2) are described in JP-As 63-285552, 05-19497, 05-70595 and 10-73944, etc.

The charge generation layer can include a low molecular weight charge transport material. Low molecular weight charge transport materials are broadly classified into electron transport materials and positive hole transport materials.

Specific examples of the electron transport materials include electron accepting materials such as chloranil, bromanil, tetracyanoethylene, tetracyanoquinodimethane, 2,4,7-trinitro-9-fluorenone, 2,4,5,7-tetranitro-9-fluorenone, 2,4,5,7-tetranitro-xanthone, 2,4,8-trinitrothioxanthone, 2,6,8-trinitro-4H-indeno[1,2-b]thiophene-4-one, 1,3,7-trinitrobenzothiophene-5,5-dioxide, diphenoxy derivatives, etc. These electron transport materials can be used alone or in combination.

Specific examples of the positive hole transport materials include electron donating materials such as oxazole derivatives, oxadiazole derivatives, imidazole derivatives, monoarylamine derivatives, diarylamine derivatives, triphenylamine derivatives, stilbene derivatives, α-phenylstilbene derivatives, benzidine derivatives, diarylmethane derivatives, triarylmethane derivatives, 9-styrylanthracene derivatives, pyrazoline derivatives, divinylbenzene derivatives, hydrazone derivatives, indene derivatives, butadiene derivatives, pyrene derivatives, bisstilbene derivatives, enamine derivatives, etc. These positive hole transport materials can be used alone or in combination.

The method for preparing the charge generation layer is not particularly limited, and a proper method is selected. For example, vacuum thin film forming methods, and casting methods using a solution/dispersion can be used.

Specific examples of such vacuum thin film forming methods include vacuum evaporation methods, glow discharge decomposition methods, ion plating methods, sputtering methods, reaction sputtering methods, CVD (chemical vapor deposition) methods, and the like methods. A layer of the above-mentioned inorganic and organic materials can be formed by one of these methods.

The casting methods useful for forming the charge generation layer include, for example, the steps of preparing a coating liquid by dispersing an inorganic or organic charge generation material in a solvent optionally together with a binder resin using a dispersing machine such as ball mills, attritors, sand mills, and bead mills; and coating the dispersion after diluting the dispersion, if necessary, to prepare the charge generation layer.

Specific examples of the solvent for use in the charge generation layer coating liquid include tetrahydrofuran, dioxane, dioxolan, toluene, dichloromethane, monochlorobenzene, dichloroethane, cyclohexanone, cyclopentanone, anisole, xylene, methyl ethyl ketone, acetone, ethyl acetate, butyl acetate, etc. The dispersion can optionally include a leveling agent such as dimethylsilicone oils, and methylphenylsilicone oils. Specific examples of the coating methods include dip coating, spray coating, bead coating, ring coating, etc.

The charge generation layer coating liquid can include a leveling agent such as dimethylsilicone oils and methylphenyl silicone oils.

The thickness of the charge generation layer is preferably from 0.01 to 5 μm, and more preferably from 0.05 to 2 μm.

### (Charge Transport Layer)

The charge transport layer has a function of retaining the charges supplied by a charger, and another function of transporting the charges generated in the charge generation layer to the surface thereof to couple the charges with the retained charges on the surface thereof, resulting in formation of an electrostatic latent image on the charge transport layer. In order to retain charges, the charge transport layer preferably has a high electric resistance. In order to obtain a high surface potential, the layer preferably has a low dielectric constant. Further, in order to efficiently transport charges, the layer preferably has a high charge mobility.

The charge transport layer includes at least a charge transport material, and optionally includes a binder resin and other components.

The positive hole transport materials, electron transport materials, and charge transport polymers mentioned above for use in the charge generation layer can be used as the charge transport material.

Specific examples of the charge transport polymers include the following.

(a) Polymers having a carbazole ring such as polyvinyl carbazole, and compounds listed in JP-As 50-82056, 54-9632, 54-11737, 04-175337, 04-183719 and 06-234841.
(b) Polymers having a hydrozone structure such as compounds listed in JP-As 57-78402, 61-20953, 61-296358, 01-134456, 01-179164, 03-180851, 03-180852, 03-50555, 05-310904 and 06-234840.
(c) Polysilylene compounds such as compounds listed in JP-As 63-285552, 01-88461, 04-264130, 04-264131, 04-264132, 04-264133 and 04-289867.
(d) Polymers having a triarylamine structure such as N,N-bis(4-methylphenyl)-4-aminopolystyrene, and compounds listed in JP-As 01-134457, 02-282264, 02-304456, 04-133065, 04-133066, 05-40350 and 05-202135.
(e) Other polymers such as nitropyrene-formaldehyde condensation polymers and compounds listed in JP-As 51-73888, 56-150749, 06-234836 and 06-234837.

In addition, polycarbonate resins, polyurethane resins, polyester resins, and polyether resins, which have a triarylamine structure can also be used as charge transport polymers. Specific examples thereof include compounds listed in 64-1728, 64-13061, 64-19049, 04-11627, 04-225014, 04-230767, 04-320420, 05-232727, 07-56374, 09-127713, 09-222740, 09-265197, 09-211877 and 09-304956.

Further, the polymers having an electron donating group are not limited to the above-mentioned polymers, and copolymers (such as block copolymers, graft copolymers, star polymers) of the above-mentioned polymers with known monomers, and crosslinked polymers having an electron donating group and disclosed in JP-A 03-109406 can also be used.

Specific examples of the binder resins for use in the charge transport layer include polycarbonate resins, polyester resins, methacrylic resins, acrylic resins, polyethylene resins, polyvinyl chloride resins, polyvinyl acetate resins, polystyrene resins, phenolic resins, epoxy resins, polyurethane resins, polyvinylidene chloride resins, alkyd resins, silicone resins, polyvinyl carbazole resins, polyvinyl butyral resins, polyvinyl formal resins, polyacrylate resins, polyacrylamide resins, and phenoxy resins. These resins can be used alone or in combination.

The charge transport layer can include a copolymer obtained from a crosslinkable binder resin and a crosslinkable charge transport material.

The charge transport layer can be typically prepared by coating a coating liquid, which is prepared by dissolving or dispersing a charge transport material and a binder resin in a proper solvent, on the charge generation layer mentioned above, followed by drying.

The solvents mentioned above for use in preparing the charge generation layer can be used for the charge transport layer coating liquid. Among the solvents, solvents which can well dissolve the charge transport material and binder resin used can be preferably used. The solvents can be used alone or in combination.

Suitable coating methods for use in preparing the charge transport layer include dip coating methods, spray coating methods, bead coating methods, ring coating methods, etc.

The charge transport layer coating liquid can optionally include additives such as plasticizers, antioxidants, and leveling agents.

Specific examples of the plasticizers include plasticizers for use in general resins such as dibutyl phthalate and dioctyl phthalate. The added amount of a plasticizer is 0 to 30 parts by weight per 100 parts by weight of the binder resin included in the charge transport layer coating liquid.

Specific examples of the leveling agents include silicone oils such as dimethyl silicone oils and methyl phenyl silicone oils; and polymers and oligomers having a side chain including a perfluoroalkyl group. The added amount of a leveling agent is 0 to 1 parts by weight per 100 parts by weight of the binder resin included in the charge transport layer coating liquid.

The thickness of the charge transport layer is not particularly limited, and is determined depending on the applications of the photoreceptor. In general, the thickness of the charge transport layer is from 5 to 40 μm, and preferably from 10 to 30 μm.

### (Substrate)

Next, the substrate of the photoreceptor will be explained. Suitable materials for use as the substrate include materials having a volume resistivity not greater than 10¹⁰Ω·cm. Specific examples of such materials include plastic cylinders, plastic films or paper sheets, on the surface of which a layer of a metal such as aluminum, nickel, chromium, nichrome, copper, gold, silver, and platinum, or a metal oxide such as tin oxides, and indium oxides, is formed using a deposition or sputtering method. In addition, a plate of a metal such as aluminum, aluminum alloys, nickel and stainless steel can be used as the substrate. A metal cylinder can also be used as the substrate. Such a metal cylinder is prepared by tubing a metal such as aluminum, aluminum alloys, nickel and stainless steel by a method such as impact ironing or direct ironing, and then subjecting the surface of the tube to cutting, super finishing, polishing and the like treatments. Further, endless belts of a metal such as nickel, and stainless steel, which are disclosed, for example, in JP-A 52-36016, can also be used as the substrate.

Furthermore, substrates, in which a coating liquid including a binder resin and an electroconductive powder is coated on the supports mentioned above, can be used as the substrate. Specific examples of such an electroconductive powder include carbon black, acetylene black, powders of metals such as aluminum, nickel, iron, nichrome, copper, zinc, and silver, and metal oxides such as electroconductive tin oxides, and ITO. Specific examples of the binder resin include known thermoplastic resins, thermosetting resins and photo-crosslinking resins, such as polystyrene, styrene-acrylonitrile copolymers, styrene-butadiene copolymers, styrene-maleic anhydride copolymers, polyesters, polyvinyl chloride, vinyl chloride-vinyl acetate copolymers, polyvinyl acetate, polyvinylidene chloride, polyarylates, phenoxy resins, polycarbonates, cellulose acetate resins, ethyl cellulose resins, polyvinyl butyral resins, polyvinyl formal resins, polyvinyl toluene, poly-N-vinyl carbazole, acrylic resins, silicone resins, epoxy resins, melamine resins, urethane resins, phenolic resins, alkyd resins, etc.

Such an electroconductive layer can be formed by coating a coating liquid in which an electroconductive powder and a binder resin are dispersed or dissolved in a proper solvent such as tetrahydrofuran, dichloromethane, methyl ethyl ketone, toluene and the like solvent, and then drying the coated liquid.

In addition, substrates, in which an electroconductive resin film is formed on a surface of a cylindrical substrate using a heat-shrinkable resin tube which is made of a combination of a resin such as polyvinyl chloride, polypropylene, polyesters, polyvinylidene chloride, polyethylene, chlorinated rubber and fluorine-containing resins (such as polytetrafluoro ethylene), with an electroconductive material, can also be used as the substrate.

### (Intermediate Layer)

An intermediate layer can be formed between the charge transport layer and the crosslinked charge transport layer to prevent migration of a material (such as charge transport materials), which is included in the charge transport layer, into the crosslinked charge transport layer or to improve the adhesion between the two layers. Therefore, it is preferable that the intermediate layer is insoluble or hardly soluble in the crosslinked charge transport layer coating liquid. The intermediate layer includes a binder resin as a main component, which is preferably insoluble or hardly soluble in the crosslinked charge transport layer coating liquid. Specific examples of the binder resin include polyamide, alcohol-soluble polyamide (alcohol-soluble nylon), water-soluble polyvinyl butyral, polyvinyl alcohol, etc. Suitable methods for preparing the intermediate layer include the coating methods mentioned above for use in preparing the charge generation layer and charge transport layer.

The thickness of the intermediate layer is not particularly limited, and is determined depending on the applications of the photoreceptor. The thickness of the intermediate layer is preferably from 0.05 to 2 μm.

### (Undercoat Layer)

The photoreceptor of the present invention can have an undercoat layer between the substrate and the photosensitive layer (charge generation layer). The undercoat layer includes a resin as a main component. Since the upper layer (such as the photosensitive layer or charge generation layer) is formed on the undercoat layer typically by coating a liquid including an organic solvent, the resin included in the undercoat layer preferably has good resistance to general organic solvents.

Specific examples of such resins include water-soluble resins such as polyvinyl alcohol resins, casein and polyacrylic acid sodium salts; alcohol soluble resins such as amide copolymers (nylon copolymers) and methoxymethylated polyamides; and thermosetting resins capable of forming a three-dimensional network such as polyurethane resins, melamine resins, alkyd-melamine resins, epoxy resins, etc.

The undercoat layer can include a metal oxide powder to prevent formation of moiré in the resultant images and to decrease residual potential of the resultant photoreceptor. Specific examples of such metal oxides include titanium oxide, silica, alumina, zirconium oxide, tin oxide, indium oxide, etc.

The undercoat layer can be formed by coating a coating liquid using a proper solvent and a proper coating method.

The undercoat layer may be formed using a silane coupling agent, titanium coupling agent or a chromium coupling agent. In addition, a layer of aluminum oxide which is formed by an anodic oxidation method, and a layer of an organic compound such as polyparaxylylene or an inorganic compound such as SiO, SnO₂, TiO₂, ITO or CeO₂ which is formed by a vacuum evaporation method can also be preferably used as the undercoat layer. The thickness of the undercoat layer is preferably 0 to 5 μm.

In order to impart high stability to withstand environmental conditions to the resultant photoreceptor (particularly, to prevent deterioration of photosensitivity and increase of residual potential), an antioxidant can be included in each of the above-mentioned layers (i.e., the crosslinked charge transport layer, charge transport layer, charge generation layer, undercoat layer, and intermediate layer).

Suitable materials for use as the antioxidant include phenolic compounds, paraphenylene diamine compounds, hydroquinone compounds, sulfur-containing organic compounds, phosphorus-containing organic compounds, etc. These compounds can be used alone or in combination.

Specific examples of the antioxidants include the following.

### (1) Phenolic Compounds

2,6-di-t-butyl-p-cresol, butylated hydroxyanisole, 2,6-di-t-butyl-4-ethylphenol, n-octadecyl-3-(4′-hydroxy-3′,5′-di-t-butylphenol), 2,2′-methylene-bis-(4-methyl-6-t-butylphenol), 2,2′-methylene-bis-(4-ethyl-6-t-butylphenol), 4,4′-thiobis-(3-methyl-6-t-butylphenol), 4,4′-butylidenebis-(3-methyl-6-t-butylphenol), 1,1,3-tris-(2-methyl-4-hydroxy-5-t-butylphenyl)butane, 1,3,5-trimethyl-2,4,6-tris(3,5-di-t-butyl-4-hydroxybenzyl)-benzene, tetrakis-[methylene-3-(3′,5′-di-t-butyl-4′-hydroxyphenyl)-propionate]methane, bis[3,3′-bis(4′-hydroxy-3′-t-butylphenyl)butyricacid]glycol ester, tocophenol compounds, etc.

### (2) Paraphenylenediamine Compounds

N-phenyl-N′-isopropyl-p-phenylenediamine, N,N′-di-sec-butyl-p-phenylenediamine, N-phenyl-N-sec-butyl-p-phenylenediamine, N,N′-di-isopropyl-p-phenylenediamine, N,N′-dimethyl-N,N′-di-t-butyl-p-phenylenediamine, etc.

### (3) Hydroquinone Compounds

2,5-di-t-octylhydroquinone, 2,6-didodecylhydroquinone, 2-dodecylhydroquinone, 2-dodecyl-5-chlorohydroquinone, 2-t-octyl-5-methylhydroquinone, 2-(2-octadecenyl)-5-methylhydroquinone, etc.

### (4) Sulfur Containing Organic Compounds

dilauryl-3,3′-thiodipropionate, distearyl-3,3′-thiodipropionate, ditetradecyl-3,3′-thiodipropionate, etc.

### (5) Phosphorus Containing Organic Compounds

triphenylphosphine, tri(nonylphenyl)phosphine, tri(dinonylphenyl)phosphine, tricresylphosphine, tri(2,4-dibutylphenoxy)phosphine, etc.

These compounds are commercialized as antioxidants for rubbers, plastics, oil and fats.

The added amount of an antioxidant in a layer is not particularly limited, and is preferably from 0.01 to 10% by weight based on the weight of the layer to which the antioxidant is added.

Next, the image forming method and apparatus of the present invention will be explained by reference to drawings.

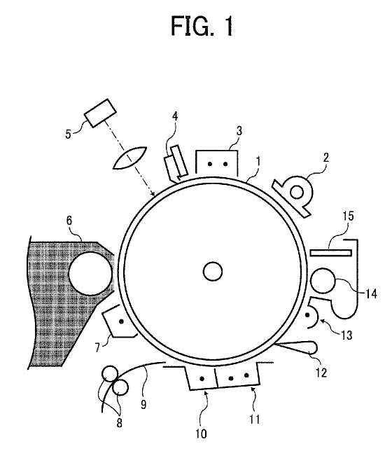

FIG. 1 is a schematic view illustrating the image forming section of an embodiment of the image forming apparatus of the present invention. The image forming apparatus includes a photoreceptor 1 which is the above-mentioned photoreceptor of the present invention. The image forming method and apparatus of the present invention perform at least a charging process in which the photoreceptor 1 is charged with a charger 3; alight irradiating process in which a light irradiating device 5 irradiates the charged photoreceptor 1 with imagewise light to form an electrostatic image thereon; a developing process in which a developing device 6 develops the electrostatic image with a developer including a toner to form a toner image on the photoreceptor 1; a transfer process in which a transferring device (including a transfer charger 10 and a separation charger 11) transfers the toner image to a receiving material 9; a fixing process in which a fixing device (not shown) fixes the toner image to the receiving material 9; and a cleaning process in which a cleaner (including a fur brush 14 and a blade 15) cleans the surface of the photoreceptor after the transfer process. The photoreceptor 1 is optionally subjected to a discharging process, in which charges remaining on the photoreceptor 1 are discharged using a discharger 2, after the transfer process. Numerals 4 and 7 respectively denote an eraser configured to erase a part of the charged portion of the photoreceptor 1, and a pre-transfer charger configured to previously charge the photoreceptor 1 so that the toner image can be well transferred onto the receiving material 9. Numerals 8 and 12 respectively denote a pair of registration rollers configured to timely feed the receiving material 9 to the transferring device 10/11, and a separation pick configured to separate the receiving material 9 from the photoreceptor 1. Numeral 13 denotes a pre-cleaning charger configured to previously charge the photoreceptor 1 so that the surface of the photoreceptor can be well cleaned with the cleaner.

The photoreceptor 1 has a drum form, but sheet-form or endless-belt-form photoreceptors can also be used for the image forming apparatus of the present invention.

Suitable chargers for use in the charger 3, pre-transfer charger 7, transfer charger 10, separation charger 11, and pre-cleaning charger 13 include known chargers capable of uniformly charging the photoreceptor, such as corotrons, scorotrons, solid state dischargers, charging rollers, etc. Combinations of a transfer charger and a separation charger are preferably used for the transfer device.

Suitable light sources for use in the light irradiating device include fluorescent lamps, tungsten lamps, halogen lamps, mercury lamps, sodium lamps, light emitting diodes (LEDs), laser diodes (LDs), light sources using electroluminescence (EL), and the like. In addition, in order to obtain light having a desired wave length range, filters such as sharp-cut filters, band pass filters, near-infrared cutting filters, dichroic filters, interference filters, color temperature converting filters and the like can be used. Such light sources can also be used for a transfer process, a discharging process, a cleaning process, and a pre-exposure process, which use light irradiation. It is preferable that the light irradiating device 5 performs digital optical recording, i.e., the device preferably irradiates the photoreceptor with light modulated by digital image signals.

The developing device 6 develops the electrostatic latent image formed on the photoreceptor 1 with a developer including a toner. Suitable developing methods include dry developing methods (such as one component developing methods using a toner as the developer and two component developing methods using a developer including a carrier and a toner).

When the photoreceptor 1, which is previously charged positively (or negatively), is exposed to imagewise light, an electrostatic latent image having a positive (or negative) charge is formed on the photoreceptor 1. When the latent image having a positive (or negative) charge is developed with a toner having a negative (or positive) charge, a positive image can be obtained. In contrast, when the latent image having a positive (negative) charge is developed with a toner having a positive (negative) charge, a negative image (i.e., a reversal image) can be obtained.

Known developing devices can be used for the developing process.

When the toner image thus formed on the photoreceptor 1 by the developing device 6 is transferred onto the receiving material 9, the entire toner image is not necessarily transferred onto the receiving material 9, and toner particles remain on the surface of the photoreceptor 1. The residual toner is removed from the photoreceptor 1 by the fur brush 14 and cleaning blade 15. In order to well clean the surface of the photoreceptor 1, the pre-cleaning charger 13 can be used. Other cleaning methods using only a brush (such as fur brushes and mag-fur brushes can also be used.

After the cleaning process, the residual charges on the photoreceptor are removed by the discharger 2. Known discharging devices can be used as the discharger 2.

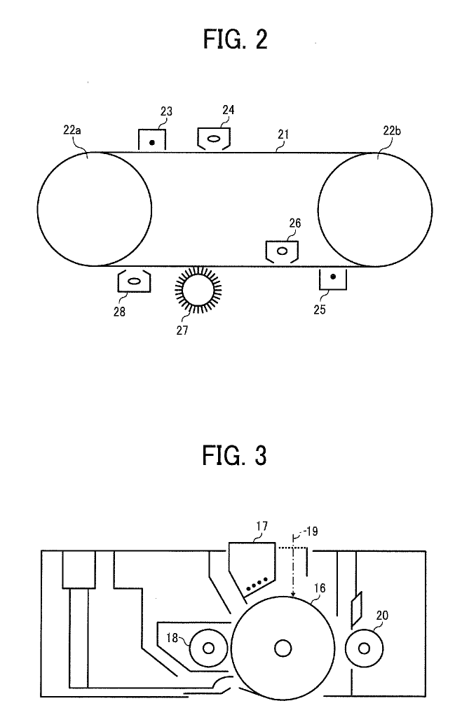

FIG. 2 illustrates another embodiment of the image forming apparatus of the present invention. Numeral 21 designates a photoreceptor which is the photoreceptor of the present invention mentioned above.

Referring to FIG. 2, the photoreceptor 21 has a belt-form. The photoreceptor 21 is rotated by rollers 22a and 22b. The photoreceptor 21 is charged with a charger 23, and then exposed to imagewise light emitted by a light irradiating device 24 to form an electrostatic latent image on the photoreceptor 21. The latent image is developed with a developing device (not shown) to form a toner image on the photoreceptor 21. The toner image is transferred onto a receiving paper (not shown) using a transfer charger 25. After the toner image transferring process, the surface of the photoreceptor 21 is cleaned with a cleaning brush 27 after performing a pre-cleaning light irradiating operation using a pre-cleaning light irradiator 26. Next, the photoreceptor 21 is discharged by being exposed to light emitted by a discharging light source 28. In the pre-cleaning light irradiating process, light irradiates the photoreceptor 21 from the substrate side of the photoreceptor 21. In this case, the substrate of the photoreceptor 21 has to be light-transmissive.

The image forming apparatus of the present invention is not limited to the image forming apparatus as shown in FIGS. 1 and 2. For example, in FIG. 2, the pre-cleaning light irradiating operation can be performed from the photosensitive layer side of the photoreceptor 21. In addition, the light irradiation in the light image irradiating process and the discharging process may be performed from the substrate side of the photoreceptor 21.

Further, a pre-transfer light irradiation operation, which is performed before the transferring of the toner image, and a preliminary light irradiation operation, which is performed before the imagewise light irradiation, and other light irradiation operations may also be performed.

The above-mentioned image forming unit can be fixedly set in an image forming apparatus such as copiers, facsimiles and printers. However, the image forming unit may be set in the image forming apparatus as a process cartridge. The process cartridge of the present invention means an image forming unit which includes a photoreceptor, which is the photoreceptor of the present invention, and at least one of a charger, an imagewise light irradiating device, a developing device, a transferring device and a cleaner. The process cartridge is detachably attachable to the image forming apparatus, for example, using a guide rail.

FIG. 3 is a schematic view illustrating an embodiment of the process cartridge of the present invention. In FIG. 3, the process cartridge includes a photoreceptor 16 which is the photoreceptor of the present invention, a charger 17 configured to charge the photoreceptor 16, a developing device (a developing roller) 20 configured to develop a latent image on the photoreceptor with a toner, an image transfer device 56 configured to transfer the toner image onto a receiving paper, and a cleaning device 18 (brush) configured to clean the surface of the photoreceptor 16. After the charging process, the charged photoreceptor is exposed to imagewise light 19 emitted by a light irradiating device to form an electrostatic latent image on the photoreceptor 16.

The image forming method and apparatus, and the process cartridge of the present invention use the photoreceptor of the present invention including, as an outermost layer, a crosslinked charge transport layer which has excellent abrasion resistance and scratch resistance without causing cracking and peeling problems. Therefore, the image forming method and apparatus, and process cartridge can be preferably used for electrophotographic image forming apparatuses such as copiers, laser printers, CRT printers, LED printers, liquid crystal printers, and laser plate making machines.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

At first, examples of the photoreceptor having a layer including a crosslinked material obtained by polymerizing a vinyl group-containing triarylamine compound having formula (1) and a radically polymerizable tri- or more-functional monomer having no charge transport structure will be explained.

### Example 1

### Formation of Undercoat Layer

The following components were mixed to prepare an undercoat layer coating liquid.

| | |
|---|---|
| Alkyd resin | 6 parts |
| (BEKKOSOL 1307-60-EL from Dainippon | |
| Ink And Chemicals, Inc.) | |
| Melamine resin | 4 parts |
| (SUPER BEKKAMINE G-821-60 from | |
| Dainippon Ink And Chemicals, Inc.) | |
| Titanium oxide | 40 parts |
| Methyl ethyl ketone | 50 parts |

The undercoat layer coating liquid was applied on a surface of an aluminum drum having an outside diameter of 30 mm, and the coated liquid was dried. Thus, an undercoat layer having a thickness of 3.5 μm was prepared.

### (Formation of Charge Generation Layer)

The following components were mixed to prepare a charge generation layer coating liquid.

| | | |
|---|---|---|
| Polyvinyl butyral resin | 0.5 | parts |
| (XYHL from Union Carbide Corporation) | | |
| Cyclohexanone | 200 | parts |
| Methyl ethyl ketone | 80 | parts |
| Bisazo pigment having the following formula | 2.4 | parts |

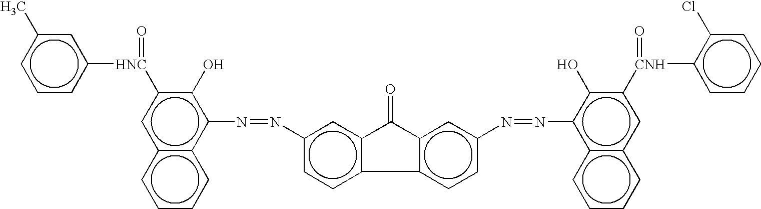

The charge generation layer coating liquid was applied on the undercoat layer, and the coated liquid was dried to prepare a charge generation layer having a thickness of 0.2 μm.

### (Formation of Charge Transport Layer)

The following components were mixed to prepare a charge transport layer coating liquid.

| | | |
|---|---|---|
| Bisphenol Z-form polycarbonate | 10 | parts |
| (PANLITE TS-2050 from Teijin Chemicals Ltd.) | | |
| Tetrahydrofuran | 100 | parts |
| 1% tetrahydrofuran solution of silicone oil | 0.2 | part |
| (Silicone oil: KF50-100CS from Shin-Etsu Chemical Co., | | |
| Ltd.) | | |
| Low molecular weight charge transport material | 7 | parts |
| having the following formula | | |
| 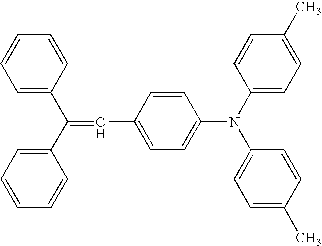 | | |

The charge transport layer coating liquid was applied on the charge generation layer, and the coated liquid was heated to be dried, resulting in preparation of a charge transport layer having a thickness of 18 μm.

### (Formation of Crosslinked Charge Transport Layer)

The following components were mixed to prepare a crosslinkable charge transport layer coating liquid.

| | |
|---|---|
| 1,2,4-trivinyl cyclohexane | 10 parts |
| (TVC from Tokyo Kasei Kogyo Co., Ltd., | |
| having molecular weight (M) of 162, number of | |
| functional groups (N) of 3, and ratio (M/N) | |
| of 54) | |
| Compound No. 1 listed in Table 1 | 10 parts |
| Tetrahydrofuran | 100 parts |

The coating liquid was applied on the charge transport layer using a spray coating method, and the coated liquid was dried for 30 minutes at 130° C. Thus, a crosslinked charge transport layer having a thickness of 5.0 μm was prepared.

Thus, a photoreceptor of Example 1 was prepared.

### Example 2

The procedure for preparation of the photoreceptor in Example 1 was repeated except that the compound No. 1 used for the crosslinkable charge transport layer coating liquid was replaced with the compound No. 3 listed in Table 1.

Thus, a photoreceptor of Example 2 was prepared.

### Example 3

The procedure for preparation of the photoreceptor in Example 1 was repeated except that the compound No. 1 used for the crosslinkable charge transport layer coating liquid was replaced with the compound No. 5 listed in Table 1.

Thus, a photoreceptor of Example 3 was prepared.

### Example 4

The procedure for preparation of the photoreceptor in Example 1 was repeated except that the temperature at which the coated crosslinkable charge transport layer coating liquid was dried was changed from 130 to 140° C.

Thus, a photoreceptor of Example 4 was prepared.

### Example 5

The procedure for preparation of the photoreceptor in Example 1 was repeated except that the temperature at which the coated crosslinkable charge transport layer coating liquid was dried was changed from 130° C. to 150° C.

Thus, a photoreceptor of Example 5 was prepared.

### Example 6

The procedure for preparation of the photoreceptor in Example 1 was repeated except that the temperature at which the coated crosslinkable charge transport layer coating liquid was dried was changed from 130° C. to 150° C. and the compound No. 1 used for the crosslinkable charge transport layer coating liquid was replaced with the compound No. 3.

Thus, a photoreceptor of Example 6 was prepared.

### Example 7

The procedure for preparation of the photoreceptor in Example 1 was repeated except that the thickness of the crosslinked charge transport layer was changed from 5.0 μm to 1.0 μm.

Thus, a photoreceptor of Example 7 was prepared.

### Example 8

The procedure for preparation of the photoreceptor in Example 1 was repeated except that the thickness of the crosslinked charge transport layer was changed from 5.0 μm to 3.0 μm.

Thus, a photoreceptor of Example 8 was prepared.

### Example 9

The procedure for preparation of the photoreceptor in Example 1 was repeated except that the thickness of the crosslinked charge transport layer was changed from 5.0 μm to 7.0 μm.

Thus, a photoreceptor of Example 9 was prepared.

### Example 10

The procedure for preparation of the photoreceptor in Example 1 was repeated except that the thickness of the crosslinked charge transport layer was changed from 5.0 Tim to 10.0 μm.

Thus, a photoreceptor of Example 10 was prepared.

### Example 11

The procedure for preparation of the photoreceptor in Example 1 was repeated except that the thickness of the crosslinked charge transport layer was changed from 5.0 μm to 12.0 μm.

Thus, a photoreceptor of Example 11 was prepared.

### Comparative Example 1

The procedure for preparation of the photoreceptor in Example 1 was repeated except that the compound No. 1 was replaced with a comparative compound No. 1 having formula (1) in which the group Ar has the following formula.

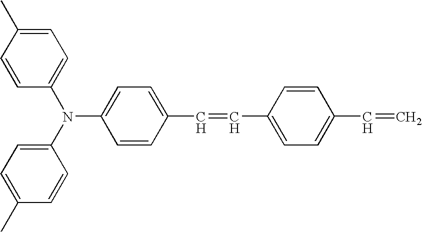

Thus, a photoreceptor of Comparative Example 1 was prepared.

### Comparative Example 2

The procedure for preparation of the photoreceptor in Example 1 was repeated except that the compound No. 1 was replaced with a comparative compound No. 2 having formula (1) in which the group Ar has the following formula.

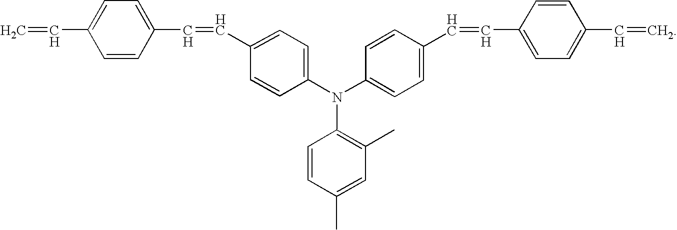

Thus, a photoreceptor of Comparative Example 2 was prepared.

### Comparative Example 3

The procedure for preparation of the photoreceptor in Example 1 was repeated except that the compound No. 1 was replaced with a comparative compound No. 3 having the following formula.

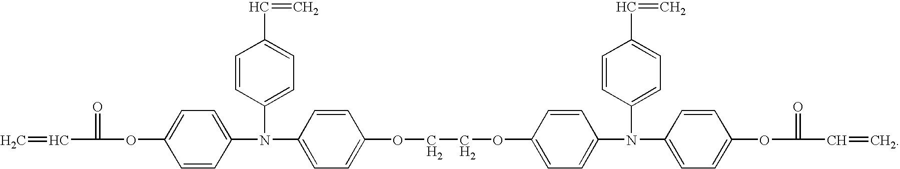

Thus, a photoreceptor of Comparative Example 3 was prepared.

### Comparative Example 4

The procedure for preparation of the photoreceptor in Example 1 was repeated except that the compound No. 1 was replaced with a comparative compound No. 4 having the following formula.

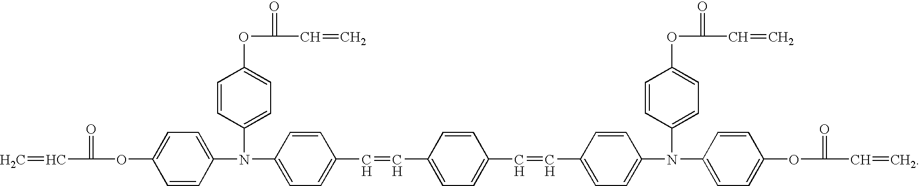

Thus, a photoreceptor of Comparative Example 4 was prepared.

### Example 12

The procedure for preparation of the photoreceptor in Example 1 was repeated except that the crosslinkable charge transport layer coating liquid was replaced with the following crosslinkable charge transport layer coating liquid.

Trimethylolpropane triacrylate 10 parts

(KAYARAD TMPTA from Nippon Kayaku Co., Ltd., having molecular weight (M) of 296, number of functional groups (N) of 3, and ratio (M/N) of 99)

| | |
|---|---|
| Compound No. 1 listed in Table 1 | 10 parts |
| Tetrahydrofuran | 100 parts |

Thus, a photoreceptor of Example 12 was prepared.

### Example 13

The procedure for preparation of the photoreceptor in Example 12 was repeated except that the compound No. 1 in the crosslinkable charge transport layer coating liquid was replaced with the compound No. 3 listed in Table 1.

Thus, a photoreceptor of Example 13 was prepared.

### Comparative Example 5

The procedure for preparation of the photoreceptor in Example 12 was repeated except that the compound No. 1 was replaced with the comparative compound No. 2 used in Comparative Example 2.

Thus, a photoreceptor of Comparative Example 5 was prepared.

### Comparative Example 6

The procedure for preparation of the photoreceptor in Example 12 was repeated except that the compound No. 1 was replaced with the comparative compound No. 3 used in Comparative Example 3.

Thus, a photoreceptor of Comparative Example 6 was prepared.

### Example 14

The procedure for preparation of the photoreceptor in Example 1 was repeated except that the crosslinkable charge transport layer coating liquid was replaced with the following crosslinkable charge transport layer coating liquid.

| | |
|---|---|
| 1,2,4-trivinyl cyclohexane | 5 parts |
| (TVC from Tokyo Kasei Kogyo Co., Ltd., | |
| having molecular weight (M) of 162, number | |
| of functional groups (N) of 3, and ratio (M/N) | |
| of 54) | |
| Dipentaerythritol hexaacrylate | 5 parts |
| (KAYARAD TMPTA from Nippon Kayaku Co., | |
| Ltd., having molecular weight (M) of 552, number | |
| of functional groups (N) of 5.5, and | |
| ratio (M/N) of 100) | |
| Compound No. 1 listed Table 1 | 10 parts |
| Tetrahydrofuran | 100 parts |

Thus, a photoreceptor of Example 14 was prepared.

### Example 15

The procedure for preparation of the photoreceptor in Example 14 was repeated except that the compound. No. 1 in the crosslinkable charge transport layer coating liquid was replaced with the compound No. 3 listed in Table 1.

Thus, a photoreceptor of Example 15 was prepared.

### Comparative Example 7

The procedure for preparation of the photoreceptor in Example 14 was repeated except that the compound No. 1 was replaced with the comparative compound No. 2 used in Comparative Example 2.

Thus, a photoreceptor of Comparative Example 7 was prepared.

### Comparative Example 8

The procedure for preparation of the photoreceptor in Example 14 was repeated except that the compound No. 1 was replaced with the comparative compound No. 4 used in Comparative Example 4.

Thus, a photoreceptor of Comparative Example 8 was prepared.

Next, examples of the photoreceptor having a layer including a crosslinked material obtained by polymerizing a vinyl group-containing triarylamine compound having formula (1), a radically polymerizable polycarbonate, and a radically polymerizable tri- or more-functional monomer having no charge transport structure will be explained.

### Example 16

The procedure for preparation of the photoreceptor in Example 1 was repeated except that the crosslinkable charge transport layer coating liquid was replaced with the following crosslinkable charge transport layer coating liquid.

| | | |
|---|---|---|
| 1,2,4-trivinyl cyclohexane | 5 | parts |
| (TVC from Tokyo Kasei Kogyo Co., Ltd., having molecular weight | | |
| (M) of 162, number of functional groups (N) of 3, and ratio (M/N) | | |
| of 54) | | |
| Aryl/Z(4/1) polycarbonate copolymer | 5 | parts |
| having the following formula | | |
| (nunber average molecular weight of 15,564, and weight average | | |
| molecular weight of 35,342) | | |

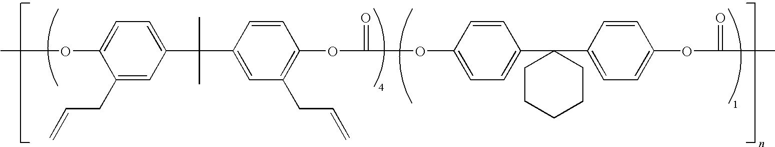

| | | |
|---|---|---|
| Compound No. 1 listed Table 1 | 10 | parts |
| Tetrahydrofuran | 100 | parts |

Thus, a photoreceptor of Example 16 was prepared.

### Example 17

The procedure for preparation of the photoreceptor in Example 16 was repeated except that the compound No. 1 was replaced with the compound No. 3 listed in Table 1.

Thus, a photoreceptor of Example 17 was prepared.

### Example 18

The procedure for preparation of the photoreceptor in Example 16 was repeated except that the compound No. 1 was replaced with the compound No. 5 listed in Table 1.

Thus, a photoreceptor of Example 18 was prepared.

### Example 19

The procedure for preparation of the photoreceptor in Example 16 was repeated except that the temperature at which the coated crosslinkable charge transport layer coating liquid was dried was changed from 130° C. to 140° C.

Thus, a photoreceptor of Example 19 was prepared.

### Example 20

The procedure for preparation of the photoreceptor in Example 1 was repeated except that the temperature at which the coated crosslinkable charge transport layer coating liquid was dried was changed from 130° C. to 150° C.

Thus, a photoreceptor of Example 20 was prepared.

### Example 21

The procedure for preparation of the photoreceptor in Example 16 was repeated except that the temperature at which the coated crosslinkable charge transport layer coating liquid was dried was changed from 130° C. to 150° C. and the compound No. 1 used for the crosslinkable charge transport layer coating liquid was replaced with the compound No. 3.

Thus, a photoreceptor of Example 21 was prepared.

### Example 22

The procedure for preparation of the photoreceptor in Example 16 was repeated except that the thickness of the crosslinked charge transport layer was changed from 5.0 μm to 1.0 μm.

Thus, a photoreceptor of Example 22 was prepared.

### Example 23

The procedure for preparation of the photoreceptor in Example 16 was repeated except that the thickness of the crosslinked charge transport layer was changed from 5.0 μm to 3.0 μm.

Thus, a photoreceptor of Example 23 was prepared.

### Example 24

The procedure for preparation of the photoreceptor in Example 16 was repeated except that the thickness of the crosslinked charge transport layer was changed from 5.0 μm to 7.0 μm.

Thus, a photoreceptor of Example 24 was prepared.

### Example 25

The procedure for preparation of the photoreceptor in Example 16 was repeated except that the thickness of the crosslinked charge transport layer was changed from 5.0 μm to 10.0 μm.

Thus, a photoreceptor of Example 25 was prepared.

### Example 26

The procedure for preparation of the photoreceptor in Example 16 was repeated except that the thickness of the crosslinked charge transport layer was changed from 5.0 μm to 12.0 μm.

Thus, a photoreceptor of Example 26 was prepared.

### Comparative Example 9

The procedure for preparation of the photoreceptor in Example 16 was repeated except that the compound No. 1 used for crosslinkable charge transport layer coating liquid was replaced with the comparative compound No. 1 used in Comparative Example 1.

Thus, a photoreceptor of Comparative Example 9 was prepared.

### Comparative Example 10

The procedure for preparation of the photoreceptor in Example 16 was repeated except that the compound No. 1 used for crosslinkable charge transport layer coating liquid was replaced with the comparative compound No. 2 used in Comparative Example 2.

Thus, a photoreceptor of Comparative Example 10 was prepared.

### Comparative Example 11

The procedure for preparation of the photoreceptor in Example 16 was repeated except that the compound No. 1 used for crosslinkable charge transport layer coating liquid was replaced with the comparative compound No. 3 used in Comparative Example 3.

Thus, a photoreceptor of Comparative Example 11 was prepared.

### Example 27

The procedure for preparation of the photoreceptor in Example 16 was repeated except that 1,2,4-trivinyl cyclohexane used for the crosslinkable charge transport layer coating liquid was replaced with 5 parts of trimethylolpropane triacrylate (KAYARAD TMPTA from Nippon Kayaku Co., Ltd.).

Thus, a photoreceptor of Example 27 was prepared.

### Example 28

The procedure for preparation of the photoreceptor in Example 27 was repeated except that the compound No. 1 used for the crosslinkable charge transport layer coating liquid was replaced with the compound No. 3 listed in Table 1.

Thus, a photoreceptor of Example 28 was prepared.

### Comparative Example 12

The procedure for preparation of the photoreceptor in Example 27 was repeated except that the compound No. 1 used for the crosslinkable charge transport layer coating liquid was replaced with the comparative compound No. 2 used in Comparative Example 2.

Thus, a photoreceptor of Comparative Example 12 was prepared.

### Comparative Example 13

The procedure for preparation of the photoreceptor in Example 27 was repeated except that the compound No. 1 used for the crosslinkable charge transport layer coating liquid was replaced with the comparative compound No. 4 used in Comparative Example 4.

Thus, a photoreceptor of Comparative Example 13 was prepared.

The gel fraction of the crosslinked charge transport layers of the photoreceptors of Examples 1-28 and Comparative Examples 1-13 was measured. The method of measuring the gel fraction is as follows.

Each of the crosslinkable charge transport layer coating liquids used in Examples 1-28 and Comparative Examples 1-13 was coated on an aluminum plate, followed by drying to prepare crosslinked charge transport layers. In this regard, the drying conditions are the same as those mentioned above in Examples 1-28 and Comparative Examples 1-13. The resultant crosslinked charge transport layers were dipped into tetrahydrofuran for 5 days at 25° C., followed by drying at room temperature.

The gel fraction of a crosslinked charge transport layer can be determined by the following equation.

GF (%)=100×(W2/W1),

wherein GF represents the gel fraction of the crosslinked charge transport layer; W1 represents the weight of the crosslinked charge transport layer before the dipping treatment; and W2 represents the weight of the crosslinked charge transport layer after the dipping treatment and the subsequent drying treatment.

The results are shown in Table 2.

TABLE 2

| | Thickness of | |
|---|---|---|
| | crosslinked charge | |
| | transport layer (μm) | Gel fraction (%) |
| Ex. 1 | 5.0 | 96 |
| Ex. 2 | 5.0 | 95 |
| Ex. 3 | 5.0 | 95 |
| Ex. 4 | 5.0 | 97 |
| Ex. 5 | 5.0 | 97 |
| Ex. 6 | 5.0 | 97 |
| Ex. 7 | 1.0 | 91 |
| Ex. 8 | 3.0 | 94 |
| Ex. 9 | 7.0 | 95 |
| Ex. 10 | 10.0 | 95 |
| Ex. 11 | 12.0 | 95 |
| Comp. Ex. 1 | 5.0 | 54 |
| Comp. Ex. 2 | 5.0 | 85 |
| Comp. Ex. 3 | 5.0 | 87 |
| Comp. Ex. 4 | 5.0 | 14 |
| Ex. 12 | 5.0 | 97 |
| Ex. 13 | 5.0 | 97 |
| Comp. Ex. 5 | 5.0 | 89 |
| Comp. Ex. 6 | 5.0 | 88 |
| Ex. 14 | 5.0 | 96 |
| Ex. 15 | 5.0 | 96 |
| Comp. Ex. 7 | 5.0 | 87 |
| Comp. Ex. 8 | 5.0 | 16 |
| Ex. 16 | 5.0 | 97 |
| Ex. 17 | 5.0 | 96 |
| Ex. 18 | 5.0 | 96 |
| Ex. 19 | 5.0 | 98 |
| Ex. 20 | 5.0 | 98 |
| Ex. 21 | 5.0 | 98 |
| Ex. 22 | 1.0 | 92 |
| Ex. 23 | 3.0 | 95 |
| Ex. 24 | 7.0 | 96 |
| Ex. 25 | 10.0 | 96 |
| Ex. 26 | 12.0 | 96 |
| Comp. Ex. 9 | 5.0 | 55 |
| Comp. Ex. 10 | 5.0 | 86 |
| Comp. Ex. 11 | 5.0 | 87 |
| Ex. 27 | 5.0 | 98 |
| Ex. 28 | 5.0 | 98 |
| Comp. Ex. 12 | 5.0 | 90 |
| Comp. Ex. 13 | 5.0 | 15 |

The photoreceptors of Examples 1-28 and Comparative Examples 1-13 were subjected to the following running test.

Each of the photoreceptors was set in an image forming apparatus (IMAGIO NEO 270 manufactured by Ricoh Co., Ltd.), in which a laser diode serving as a light source irradiates the photoreceptor, which has been charged to have a potential of −900V, with light of 655 nm to form an electrostatic latent image on the photoreceptor, and the electrostatic latent image is developed with a developer including a toner, which has a volume average particle diameter of 9.5 μm and an average circularity of 0.91 and includes a silica as an external additive. Next, a running test in which 50,000 copies of an original image are continuously produced was performed. At the beginning and end of the running test, the potential of an irradiated portion of the photoreceptor, which portion receives light of 0.4 μJ/cm², was measured, and the image was visually observed to determine the image qualities. In addition, the abrasion loss of the photoreceptor was determined from the difference in thickness between the photoreceptor before the running test and the photoreceptor after the running test. Further, the image at the end of the running test was visually observed to determine the number of white spots in a solid image.

The results are shown in Tables 3-1 and 3-2.

TABLE 3-1

| | At the beginning of running test | |
|---|---|---|
| | Potential of | |
| | irradiated | |
| | portion (−V) | Image qualities |
| Ex. 1 | 95 | Good |
| Ex. 2 | 65 | Good |
| Ex. 3 | 70 | Good |
| Ex. 4 | 97 | Good |
| Ex. 5 | 100 | Good |
| Ex. 6 | 68 | Good |
| Ex. 7 | 150 | Slightly low image density |
| Ex. 8 | 85 | Good |
| Ex. 9 | 105 | Good |
| Ex. 10 | 120 | Good |
| Ex. 11 | 140 | Slightly low image density |
| Comp. Ex. 1 | 50 | Good |
| Comp. Ex. 2 | 75 | Good |
| Comp. Ex. 3 | 300 | Seriously low image |
| | | density |
| Comp. Ex. 4 | 130 | Good |
| Ex. 12 | 145 | Slightly low image density |
| Ex. 13 | 110 | Good |
| Comp. Ex. 5 | 105 | Good |
| Comp. Ex. 6 | 424 | The image could not be |
| | | evaluated because of |
| | | having too low image |
| | | density. |
| Ex. 14 | 105 | Good |
| Ex. 15 | 80 | Good |
| Comp. Ex. 7 | 95 | Good |
| Comp. Ex. 8 | 155 | Slightly low image density |
| Ex. 16 | 97 | Good |
| Ex. 17 | 68 | Good |
| Ex. 18 | 73 | Good |
| Ex. 19 | 100 | Good |
| Ex. 20 | 102 | Good |
| Ex. 21 | 73 | Good |
| Ex. 22 | 155 | Slightly low image density |
| Ex. 23 | 90 | Good |
| Ex. 24 | 107 | Good |
| Ex. 25 | 125 | Good |
| Ex. 26 | 145 | Slightly low image density |
| Comp. Ex. 9 | 55 | Good |
| Comp. Ex. 10 | 77 | Good |
| Comp. Ex. 11 | 315 | Seriously low image |
| | | density |
| Ex. 27 | 110 | Good |
| Ex. 28 | 84 | Good |
| Comp. Ex. 12 | 100 | Good |
| Comp. Ex. 13 | 165 | Slightly low image density |

TABLE 3-2

| | At the end of running test | | | |
|---|---|---|---|---|
| | Potential | | | Number of |
| | of | | | white |
| | irradiated | | Abrasion | spots |
| | portion | | loss | (per |
| | (−V) | Image qualities | (μm) | 100 cm²) |
| Ex. 1 | 97 | Good | 1.2 | 5-10 |
| Ex. 2 | 70 | Good | 1.1 | 5-10 |
| Ex. 3 | 73 | Good | 1.1 | 5-10 |
| Ex. 4 | 105 | Good | 0.9 | 0-5 |
| Ex. 5 | 110 | Good | 0.7 | 0-5 |
| Ex. 6 | 72 | Good | 0.6 | 0-5 |
| Ex. 7 | 45 | Good | 1.5 | 10-20 |
| Ex. 8 | 84 | Good | 1.3 | 5-10 |
| Ex. 9 | 111 | Good | 1.2 | 5-10 |
| Ex. 10 | 127 | Good | 1.2 | 5-10 |
| Ex. 11 | 150 | Slightly low | 1.3 | 5-10 |
| | | image density | | |
| Comp. Ex. 1 | 46 | Good | 8.9 | 50-60 |
| Comp. Ex. 2 | 60 | Good | 4.7 | 20-30 |
| Comp. Ex. 3 | 150 | Slightly low | 4.5 | 20-30 |
| | | image density | | |
| Comp. Ex. 4 | 47 | Good | 8.8 | 10-20 |
| Ex. 12 | 180 | Slightly low | 1.1 | 0-5 |
| | | image density | | |
| Ex. 13 | 150 | Slightly low | 1.0 | 0-5 |
| | | image density | | |
| Comp. Ex. 5 | 100 | Good | 4.5 | 20-30 |
| Comp. Ex. 6 | 145 | Slightly low | 4.4 | 20-30 |
| | | image density | | |
| Ex. 14 | 120 | Good | 2.1 | 0-5 |
| Ex. 15 | 90 | Good | 1.0 | 0-5 |
| Comp. Ex. 7 | 54 | Good | 4.7 | 20-30 |
| Comp. Ex. 8 | 49 | Good | 8.6 | 10-20 |
| Ex. 16 | 100 | Good | 1.0 | 5-10 |
| Ex. 17 | 75 | Good | 0.9 | 5-10 |
| Ex. 18 | 80 | Good | 0.9 | 5-10 |
| Ex. 19 | 115 | Good | 0.7 | 0-5 |
| Ex. 20 | 120 | Good | 0.5 | 0-5 |
| Ex. 21 | 80 | Good | 0.4 | 0-5 |
| Ex. 22 | 47 | Good | 1.4 | 10-20 |
| Ex. 23 | 95 | Good | 1.2 | 5-10 |
| Ex. 24 | 119 | Good | 1.0 | 5-10 |
| Ex. 25 | 135 | Good | 1.0 | 5-10 |
| Ex. 26 | 155 | Slightly low | 1.2 | 5-10 |
| | | image density | | |
| Comp. Ex. 9 | 47 | Good | 8.9 | 50-60 |
| Comp. Ex. 10 | 62 | Good | 4.5 | 20-30 |
| Comp. Ex. 11 | 152 | Slightly low | 4.6 | 20-30 |
| | | image density | | |
| Ex. 27 | 125 | Good | 0.8 | 0-5 |
| Ex. 28 | 95 | Good | 0.7 | 0-5 |
| Comp. Ex. 12 | 60 | Good | 4.3 | 20-30 |
| Comp. Ex. 13 | 48 | Good | 8.3 | 10-20 |

It is clear from Tables 3-1 and 3-2 that the photoreceptors of Examples 1-28 have good abrasion resistance and produce images with a small number of white spots over a long period of time. This is because the surface of the photoreceptors is hardly stuck by the silica included in the toner. Among the photoreceptors of Examples 1-28, the photoreceptors having a crosslinked charge transport layer having a gel fraction of not less than 95% are superior in the white spot quality. Further, the photoreceptors having a crosslinked charge transport layer having a gel fraction of not less than 97% have excellent abrasion resistance and hardly produce white spots. When the thickness of the crosslinked charge transport layer is not less than 3 μm, the resultant photoreceptors have excellent abrasion resistance and produce high quality images free from defects.

Additional modifications and variations of the present invention are possible in light of the above teachings. It is therefore to be understood that within the scope of the appended claims the invention may be practiced other than as specifically described herein.

This document claims priority and contains subject matter related to Japanese Patent Application No. 2008-235992, filed on Sep. 16, 2008, the entire contents of which are herein incorporated by reference.

What is claimed is:

1. A photoreceptor comprising:
a layer including a crosslinked material obtained by polymerizing at least a vinyl group-containing triarylamine compound having the below-mentioned formula (1), and a radically polymerizable monomer which has at least three radically polymerizable groups in a molecule and has no charge transport structure: 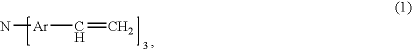
wherein Ar represents an aryl group or a substituted aryl group.

2. The photoreceptor according to claim 1, wherein the crosslinked material is obtained by polymerizing at least a vinyl group-containing triarylamine compound having formula (1), a polycarbonate having a radically polymerizable group, and a radically polymerizable monomer which has at least three radically polymerizable groups in a molecule and has no charge transport structure.

3. The photoreceptor according to claim 2, wherein the polycarbonate has the following formula (5): 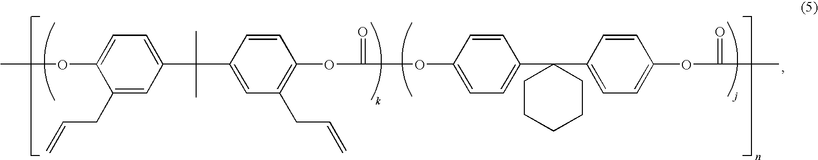
wherein k and j represent molar ratio of units, and each of k and j is a positive integer; and n is a repeat number of the units and is a positive integer.

4. The photoreceptor according to claim 1, wherein the vinyl group-containing triarylamine compound is a tristyrylstyryl amine compound having the following formula (2):

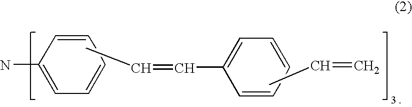

5. The photoreceptor according to claim 1, wherein the vinyl group-containing triarylamine compound is a tristyrylstyryl amine compound having the following formula (3): 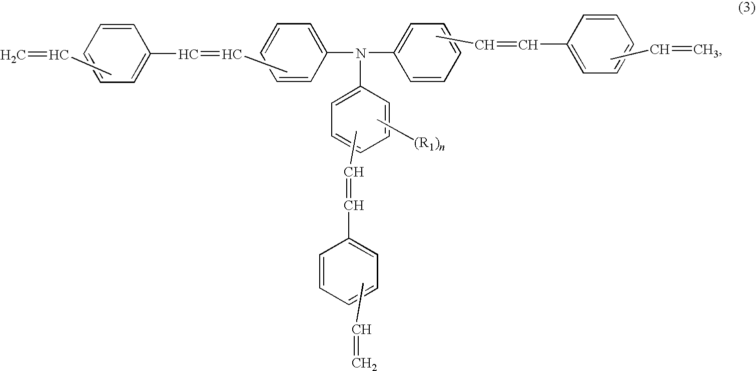
wherein R₁ represents an alkyl group having not greater than 8 carbon atoms, an alkenyl group having not greater than 8 carbon atoms, an alkoxyl group having not greater than 8 carbon atoms, an aryl group having not greater than 8 carbon atoms, or an alaryl group having not greater than 8 carbon atoms; and n is 0, 1, 2 or 3.

6. The photoreceptor according to claim 1, wherein the radically polymerizable monomer which has at least three radically polymerizable groups in a molecule and has no charge transport structure is 1,2,4-trivinylcyclohexane having the following formula (4):

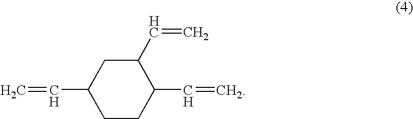

7. The photoreceptor according to claim 6, wherein the crosslinked material is obtained by polymerizing at least a vinyl group-containing triarylamine compound having the below-mentioned formula (2), and the radically polymerizable monomer having formula (4) without using a polymerization initiator:

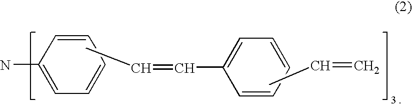

8. The photoreceptor according to claim 6, wherein the crosslinked material is obtained by polymerizing at least a vinyl group-containing triarylamine compound having the below-mentioned formula (2), a polycarbonate having a radically polymerizable group, and the radically polymerizable monomer having formula (4) without using a polymerization initiator:

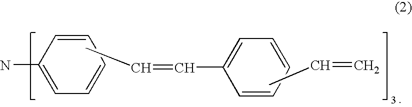

9. The photoreceptor according to claim 1, wherein the radically polymerizable monomer is a radically polymerizable monomer which has three radically polymerizable groups in a molecule and has no charge transport structure or a combination of a radically polymerizable monomer which has three radically polymerizable groups in a molecule and has no charge transport structure and a radically polymerizable monomer which has five or six radically polymerizable groups in a molecule and has no charge transport structure.

10. The photoreceptor according to claim 1, wherein the layer is an outermost layer of the photoreceptor.

11. The photoreceptor according to claim 1, further comprising:
a substrate;
a charge generation layer configured to generate a charge, which is located overlying the substrate; and
a charge transport layer configured to transport the charge, which is located on the charge generation layer,
wherein the layer including the crosslinked material is located overlying the charge transport layer as an outermost layer.

12. The photoreceptor according to claim 11, wherein the crosslinked material is obtained by polymerizing at least a vinyl group-containing triarylamine compound having formula (1), a polycarbonate having a radically polymerizable group, and a radically polymerizable monomer which has at least three radically polymerizable groups in a molecule and has no charge transport structure.

13. An image forming method comprising:
charging the photoreceptor according to claim 1;
irradiating the charged photoreceptor with imagewise light to form an electrostatic latent image on the photoreceptor;
developing the electrostatic latent image with a developer including a toner to form a toner image on the photoreceptor; and
transferring the toner image onto a receiving material.

14. The image forming method according to claim 13, wherein the imagewise light is light modulated by digital image signals.

15. An image forming apparatus comprising:
the photoreceptor according to claim 1;
a charger configured to charge the photoreceptor;
a light irradiating device configured to irradiate the charged photoreceptor with imagewise light to form an electrostatic latent image on the photoreceptor;
a developing device configured to develop the electrostatic latent image with a developer including a toner to form a toner image on the photoreceptor; and
a transferring device configured to transfer the toner image onto a receiving material.

16. The image forming apparatus according to claim 15, wherein the light irradiating device irradiates the charged photoreceptor with light modulated by digital image signals to form an electrostatic latent image on the photoreceptor.

17. A process cartridge comprising:
the photoreceptor according to claim 1; and
at least one of a charger configured to charge the photoreceptor;
a light irradiating device configured to irradiate the charged photoreceptor with imagewise light to form an electrostatic latent image on the photoreceptor;
a developing device configured to develop the electrostatic latent image with a developer including a toner to form a toner image on the photoreceptor;
a transferring device configured to transfer the toner image onto a receiving material; and
a cleaner configured to clean a surface of the photoreceptor after then toner image is transferred onto the receiving material,
wherein the process cartridge is detachably attachable to an image forming apparatus as a unit.
